(19) United States
(12) Patent Application Publication
(10) Pub. No.: US 2005/0108268 A1
(43) Pub. Date: May 19, 2005

(54) Company board data processing system and method

(76) Inventors: Julian Saintry, London (GB); Richard Berman, London (GB); David Fletcher, London (GB); Helene Regnault Jette, Paris (FR); Linda Russheim, London (GB); Andrew Mcmullan, Bucks (GB)

Correspondence Address: DICKSTEIN SHAPIRO MORIN & OSHINSKY LLP, 2101 L Street, NW, Washington, DC, 20037, US

(21) Appl. No.: 10/476,975

(22) PCT Filed: Mar. 14, 2002
(86) PCT No.: PCT/GB02/01202

Related U.S. Application Data
(60) Provisional application No. 60/289,229, filed on May 7, 2001.

(51) Int. Cl. G06F 7/00

(52) U.S. Cl. 707/102

(57) ABSTRACT

A company board data processing system and method provides a user interface platform to supply information related to members of boards of companies to enable comparison of board members or boards at board member level. Parameters related to board members of a plurality of boards are stored. A used interface is generated which comprises a display of the parameters related to board members for a plurality of boards and/or individuals board members to allow comparison of board members and/or boards at boards member level. The system also allows the user to define a group of boards and/or board members, wherein processed parameters for said group can be used for comparison purposes.

### FIELD OF INVENTION

This invention relates to a data processing system and method for processing and presenting a wide range of data related to the Board of Directors of companies, as well as the members of those Boards individually.

### BACKGROUND

Investing on the Stock Markets inevitably involves a risk on behalf of the investor, equities can go up or down and there is never any guarantee of a positive return from your investment. However this uncertainty can be reduced considerably by investing wisely and more importantly by investing only in things that you have knowledge of. You will have more chance of winning if you bet on a horse based on its form than you will if you take a guess from a list of starters without any knowledge of any of them, and so it is with the equity markets that a sensible investor will only buy or sell a stock based on sound information.

It is the requirement for this information across the stock markets of the world which has led to the existence of the world-wide Investment Banks and a plethora of financial advisors. It is almost impossible for a fund manager or private investor to be able to make an informed decision on a stock without some form of advice on the economic conditions of that company, its past history, future prospects, products, staff, etc. . . . This advice can come in many forms depending on the information sought, for instance there are a large number of sources of company focussed economic data, information such as the price/earnings ratio, the profit & loss figures etc . . . , well known financial statistics which can give an indication as to the stock's current worth and potential.

However, there are other forms of information that are more subjective by their very nature, and many of the large investment houses have teams of analysts trying to get behind the financial figures to tell the real story. The problem with such information is that it is not as reliable as the hard economic facts, it often emanates from person to person meetings, press conferences and rumour. It is not possible for a fund manager or investor to attend every annual general meeting, read every end of year report and interview every Board of Directors, and hence it is the analyst's job to try to do this for the investor, and it is left to the investor to attempt to read the analyst's report and pick out the information that he is looking for. This, inevitably increases the risk of following the information and advice supplied, especially as two different analysts will often have a completely opposite view on the potential of any particular company. Unfortunately there are very few alternatives, and whilst the use of analyst reports helps it still rarely allows for comparison across the whole spectrum of the market because analysts will often have a specialised sector and hence comparative data across a range of stocks in this field of information can be difficult to find and often lacking in user friendliness.

Hence it is the object of the proposed invention to supply a user friendly tool to aid in information provision.

### SUMMARY OF THE INVENTION

A first aspect of the present invention provides a company board data processing system and method which provides a user interface platform to supply information related to members of boards of companies to enable comparison of board members or boards at board member level. Parameters related to board members of a plurality of boards are stored. The boards of which the board members are members is indicated in the stored parameters. A user interface is generated which comprises a display of the parameters related to board members for a plurality of boards and/or individual board members to, allow comparison of board members and/or boards at board member level.

Thus this aspect of the present invention provides a tool which can be used by analysts to review parameters related to boards at the level of granularity of board member parameters.

In one embodiment of this aspect of the present invention, parameters for a group of board members such as a board or some other predetermined group is processed to determine process parameters which can comprise one or a number of: parameter totals, parameter averages and parameter deviations. Thus the user interface can display such process parameters for comparison with boards at board member level or with individual board members.

In one embodiment of this aspect of the present invention the group can comprise a group of boards in which case the process parameters comprise parameters processed for a number of boards and thus represents totals, averages or deviations for the boards. This enables the board as a whole and individual members of the board to be compared to a number of boards.

In an alternative embodiment of this aspect of the present invention the group comprises a group of board members. The group of board members can comprise board members of a single board, or board members across a number of boards. This enables individual board members to be compared with a peer group of board members from a number of boards.

A second aspect of the present invention provides a company board data processing system and method in which parameters related to board members of a plurality of boards is stored. The system receives a user selection of at least one board and/or board member for inclusion in a peer group. Parameters for constituents of a peer group are processed to determine processed parameters for the peer group and these processed parameters are output. Preferably the processing determines one or more peer group parameter totals, one or more peer group parameter averages and one or more peer group parameter deviations.

This aspect of the present invention provides a useful tool to enable a user to select and form a peer group comprised of a number of board members which need not be in the same board. This aspect of the present invention also allows the selection of boards for inclusion in a board peer group. Parameters for boards are processed to determine process parameters for the board peer group. Thus a board peer group can be used for comparison with a board to allow comparative analysis.

In one embodiment of this aspect of the present invention the peer group data is stored for at least one user selected peer group. The user interface can display a list of existing peer groups to allow a user to select one or more of the existing peer groups. Process parameters for the or each selected peer group can then be output for display, e.g. for comparative purposes.

In one embodiment of this aspect of the present invention, the constituents of the peer groups can be amended. This amendment can take the form of allowing constituents of a peer group, e.g. a board member or board, to be transferred from one peer group to another.

In another embodiment of this aspect of the present invention predefined groups of boards and/or board members are stored with parameters related to the peer groups as predefined peer groups. The user interface can display a list of the predefined peer groups to allow a user to select one or more of them for output for comparative purposes.

Another aspect of the present invention provides a company board data processing system in which predefined groups of boards and/or board members comprising peer groups and predefined parameters related to the peer groups are stored. The system is arranged to output a list of the peer groups to allow a user to select one or more of the peer groups from the list. As a result of the selection at least one of the predefined parameters for the or each selected peer group is output. The parameters can be displayed and used for comparative purposes.

In this aspect of the present invention a peer group which can comprise parameters for groups of boards and/or board members is predefined. In one embodiment, however, a user can modify a predefined peer group by adding constituents, i.e. boards or board members, or removing constituents. Also, constituents can be moved from group to group. Thus this embodiment provides a flexible tool for comparison of board members and boards with peer groups.

In one embodiment the predefined parameters for the peer groups comprise process parameters. The process parameters can comprise peer group parameter totals, peer group parameter averages and peer group parameter deviations.

Another aspect of the present invention provides a company board data processing system and method in which board member related parameters for a plurality of board members is stored. A deviation of said board member related parameters from predetermined parameters is determined and this is used by a user interface to generate a display of at least one board member related parameter highlighted in accordance with the determined deviations.

This embodiment of the present invention provides a system in which deviations of parameters related to board members from predetermined parameters is displayed in a clear form by highlighting such parameters in accordance with the deviations. This allows these deviations and patterns in these deviations to be easily distinguishable.

In one embodiment of the present invention the user interface is generated to highlight each board member related parameter in one of a plurality of colours, where the colour relates to the relative value of the determined deviation.

In one embodiment of this aspect of the present invention the predetermined parameters relate to a group of board members comprising a peer group. In this embodiment predetermined parameters can relate to totals, averages and/or deviations of the parameters of the members of the peer group.

In one embodiment of this aspect of the present invention the user interface generates a table of data comprising a plurality of cells. Each cell contains a board member related parameter or a predetermined parameter. Cells containing the board member related parameters are highlighted in accordance with the determined deviation. In a preferred embodiment these cells are highlighted in one of a plurality of colours, wherein the colours relate to the relative value of the determined deviations.

In another aspect of this aspect of the present invention there is provided a company board data processing system and method in which board member related parameters are stored for a plurality of boards. A user interface generates a multi-axis plot of one or more of the board member related parameters for one or more boards and/or board members to allow comparison of these parameters. Thus this aspect of the present invention provides a graphical user interface tool for the visualization of company board data at a company board member level of granularity.

In one embodiment of this aspect of the present invention the board members can be grouped into groups and the user interface can generate a display of a multi-axis plot of parameters related to a group of board members. In one embodiment this can be used for comparative purposes to allow parameters related to a board or individual members of a board to be plotted against the group.

In one embodiment of the present invention the axes of the multi-axis plot can be scaled based on a plurality of parameters for a plurality of board members. This can comprise totals, averages or deviations for parameters for a plurality of board members.

A further aspect of the present invention provides a company board data processing system in which a number of shares owned by at least one board member in a company in which they are a board member are stored. The current share price of the company in which the board member is a member of the board is determined and used with the number of shares to determine the value of the shares held by the board member to determine a wealth index for the board member. The wealth index comprises an increase in wealth related to the company when the share price increases by an amount, e.g. 1%.

This aspect of the present invention provides an indicator of the wealth related motivation of a board member to improve the performance of a company. If a board member holds a large number of shares, they have a personal interest in improving the performance of a company so that the share price increases.

Another aspect of the present invention provides a system for analyzing a created company board. Parameters related to a plurality of board members are stored. A user can select at least one board member for inclusion in at least one created company board. Board parameters for constituents of the created company board are generated. The board member parameters and/or the generated board parameters can be output to allow the created board to be the subject of analysis.

Thus this aspect of the present invention provides a means by which a user of the system can create a “fantasy” board comprised of a number of board members currently members of other boards. Parameters related to the board members for the created company board can then be analysed. Thus this aspect of the present invention can be used as a tool by which users can identify suitable board members for building a company board for a new company or for replacing board members of an existing company board.

A further aspect of the present invention provides a board member level recruitment and analysis tool and method in which parameters related to a plurality of board members are stored. A user is able to select at least one board member to be the subject of analysis and to select at least one other board member to be used as a comparison in the board member analysis. A user interface generates a display of the parameters of the selected board members subject to analysis and the selected comparison board members to allow recruitment related comparison of the two sets of parameters.

Another aspect of the present invention provides a company board data processing system and method in which a graphical display is generated to show the performance of a company and a board member history on a time basis. This aspect of the present invention allows a user to identify the effect of a board member on the performance of a company.

Although the present invention has been described hereinabove with reference to a number of separate aspects, in accordance with the present invention, any aspect of the present invention described hereinabove can be used in conjunction with any other aspect of the present invention.

The present invention is applicable to financial analysis and in management of companies. For example, the present invention can be used by fund managers for managing a portfolio of investments by analyzing company board member parameters. The presentation of the data can be by any suitable output means such as a display or printer. The output can also be an output over a network to provide for presentation, e.g. display, at a remote location. The present invention is applicable to a stand alone system or a network system in which the server receives requests from a user of a client and outputs data for presentation to the user by the client.

All aspects of the present invention can be implemented on dedicated hardware, a combination of dedicated hardware and suitably programmed hardware, or on a programmed general purpose computer. The present invention thus encompasses computer readable instructions for controlling a computer to carry out the methods. Computer readable instructions can be provided to a general purpose computer on any suitable carrier medium such as a transient medium, e.g. an electrical, optical, microwave, acoustic or radio frequency signal (e.g. a signal (carrier wave) carrying computer readable instructions over a network such as the Internet), or a storage medium such as a floppy disk, hard disk, CD-ROM or solid state memory device.

### BRIEF DESCRIPTION OF THE DRAWINGS

Embodiments of the present invention will now be described with reference to the accompanying drawings, in which:

FIG. 1 is a schematic diagram of a company board data processing system in accordance with an embodiment of the present invention;

FIG. 2 illustrates the top level structure of the user interface information pages;

FIG. 3 illustrates the information page structure of the Board Associations data section;

FIG. 4 illustrates the information page structure of the Board Remuneration data section;

FIG. 5 illustrates the information page structure of the Board Characteristics data section;

FIG. 6 illustrates the information page structure of the Director Associations data section;

FIG. 7 illustrates the information page structure of the Director Remuneration data section;

FIG. 8 illustrates the information page structure of the Director Characteristics data section;

FIG. 9 is a screen shot of a user interface ‘Board Summary’ information page;

FIG. 10 is a screen shot of a user interface ‘Board Single & Multi Associations’ information page;

FIG. 11 is a screen shot of a user interface ‘Board Remuneration Summary Table’ information page;

FIG. 12 is a screen shot of a user interface ‘Board Remuneration Summary Bubble Chart’ information page;

FIG. 13 is a screen shot of a user interface ‘Board Remuneration Ratios’ information page;

FIG. 14 is a screen shot of a user interface ‘Board Characteristics Network/Biographical’ information page;

FIG. 15 is a screen shot of a user interface ‘Board Characteristics Change Table’ information page;

FIG. 16 is a screen shot of a user interface ‘Board Characteristics Diversity Table’ information page;

FIG. 17 is a screen shot of a user interface ‘Board Characteristics Diversity Radar Chart information page;

FIG. 18 is a screen shot of a user interface ‘Board Peer Group Management’ information page;

FIG. 19 is a screen shot of a user interface ‘Board Peer Group Member’ information page;

FIG. 20 is a screen shot of a user interface ‘Board Advanced Search’ information page,

FIG. 21 is a screen shot of a user interface ‘Board Search Results’ information page;

FIG. 22 is a screen shot of a user interface ‘Director Summary’ information page;

FIG. 23 is a screen shot of a user interface ‘Director Single & Multi Associations’ information page;

FIG. 24 is a screen shot of a user interface ‘Director Remuneration Ratios’ information page;

FIG. 25 is a screen shot of a user interface ‘Director Characteristics Roles’ information page;

FIG. 26 is a screen shot of a user interface ‘Director Characteristics Experience Table’ information page;

FIG. 27 is a screen shot of a user interface ‘Director Characteristics Experience Radar Chart’ information page;

FIG. 28 is a screen shot of a user interface ‘Director Peer Group Management’ information page;

FIG. 29 is a screen shot of a user interface ‘Director Peer Group Member’ information page;

FIG. 30 is a screen shot of a user interface ‘Director Advanced Search’ information page;

FIG. 31 is a screen shot of a user interface ‘Director Search Results’ information page;

FIG. 32 is a screen shot of a user interface ‘Board Timeline’ information page;

FIG. 33 is a screen shot of a user interface ‘Board Share Price History’ information page;

FIG. 34 is a screen shot of a user interface ‘Board and Shareholder Returns’ information page;

FIG. 35 is a screen shot of a user interface ‘Board Time Analysis’ information page;

FIG. 36 is a screen shot of a user interface ‘Board Experience over Time’ information page;

FIG. 37 is a screen shot of a user interface ‘Director Multi Associations’ information page;

FIG. 38 is a screen shot of a user interface ‘Director Share Price History’ information page;

FIG. 39 is a screen shot of a user interface ‘Board Peer Group Alerts Set-Up’ information page;

FIG. 40 is a screen shot of a user interface ‘Board Peer Group Alerts Results’ information page;

FIG. 41 is a screen shot of a user interface ‘Director Peer Group Alerts Set-Up’ information page; and

FIG. 42 is a screen shot of a user interface ‘Director Peer Group Alerts Results’ information page.

### DESCRIPTION OF PREFERRED EMBODIMENTS

General Introduction

There are many systems that provide information regarding companies listed on the stock markets of the world, but that there is a gap in the market for an analysis tool that is focussed on the actual members of the Boards of these companies. Such information is currently hard to find and more importantly difficult to analyse and often unreliable. The system of the embodiment of the present invention allows people to view and analyse the people who actually run these listed companies and hence offer a platform for people to form an indicative view of another very important aspect in measuring the potential success, or otherwise, of such companies that has so far been very difficult to grasp.

The system offered by the embodiment of the current invention allows the user to select an entire Board and analyse and compare the credentials of each member of that Board. Also, one or more other Boards can be selected, by the user, and corresponding data can be displayed simultaneously to allow a comparison of the selected Boards against one another, hence providing the statistics that can be used to measure the relative merits of one Board against another. This system provides a platform of user interactive analysis that has not been previously available and that will greatly benefit anyone investing in stock market listed companies.

However, the usefulness of such a tool is not restricted to the financial markets.

Anyone who wished to compare the skills, experience and background history of one or more Director level individuals, say for recruitment purposes, would also find this tool very effective in their analysis. The system allows the user to select an individual and view data on all of his Board-level roles, and also offers the chance to select one or more other individuals to be displayed simultaneously and used in the analysis.

Hardware

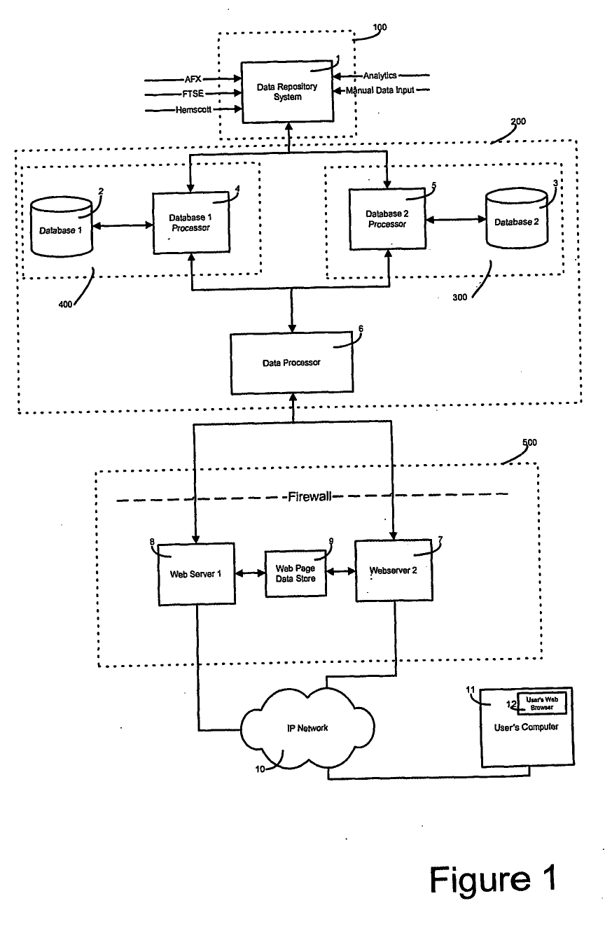

The preferred embodiment of the current invention is illustrated in FIG. 1 and comprises an architecture structure that is made up of a Data Repository System, 1, a Database System, 2, 3, 4, 5, a Data Processor, 6, a web Server system, 7, 8, 9, and a User's computer, 11.

The Data Repository System, 1, is located at a central data entry and management location, 100. It comprises a unified data entry point and is the tool with which all raw data is entered into the system. The Data Repository System 1 acts as a master database for the data in the system and receives data via one of two methods: manual data entry; or automatic data entry.

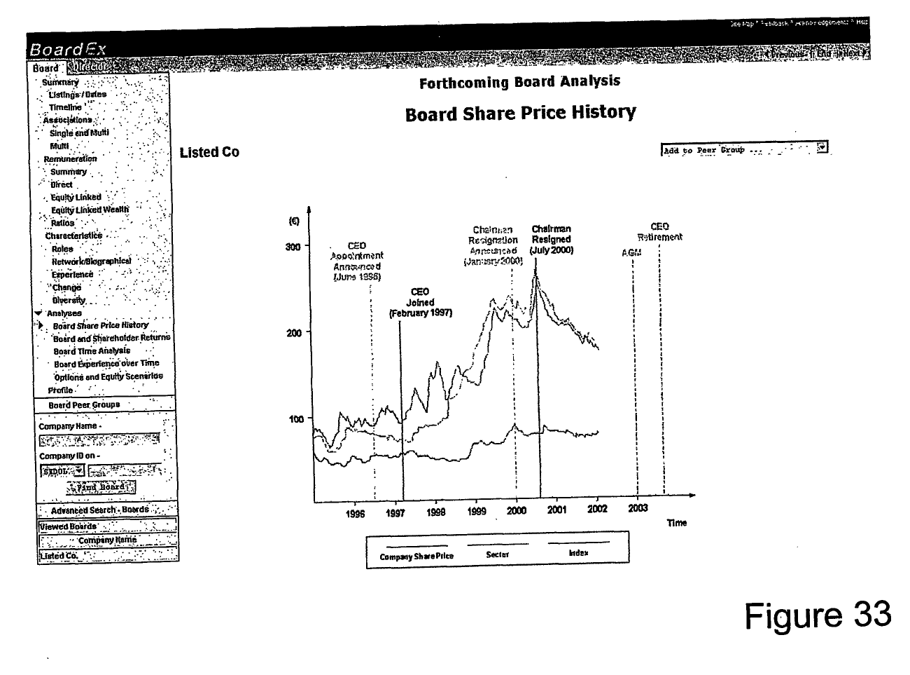

The manual data entry system comprises a computer system with a user interface based at the central data entry and management location, 100. This user interface allows manual entry of new data raw data parameters as well as the entry of some manual analytics. It comprises two interfaces, one for the entry of data relating to a Director Profile and the other for the entry of data relating to a Board profile. The raw data comprises simple numerical values, such as a Director's salary, that are described hereafter. The manual analytics data entry comprises such data as, for example, a company time-line share price graph that has been manually amended to display key corporate actions during the time period displayed, for example the departure of a CEO from the Board or a new company share issue, such as that shown in FIG. 33.

The automatic data entry system comprises on on-line feed to a number of financial data providers, such as FT, AFX and Hernscott. This data is downloaded periodically, daily in the case of the preferred embodiment of the invention, into a data store, where it is checked both by manual and automatic means before being populated onto the Master Database.

The raw data parameters that are entered via the manual and automatic data entry systems comprise parameters related to Board members and parameters related to Boards and include:
Salary
Bonus
Pension Contributions
Other remuneration
Role
Number of Options awarded
Stock Price
Option Exercise Price
Options time to expiry
Dividend Yield
Number of Directors at the start of the Year
Number of Directors at the end of the Year
Equity awarded
LTIP Contributions awarded
Number of Executives and Non-executives in the company
Age of Director
Time in Company of Director
Time on Board of Director
Board's policy retirement Age
Time to retirement for Director
Name
Role
Director's Direct Compensation
Director's sex
Director's Nationality
Director's past employment
Director's Qualifications
Director's Shared external Directorships
Total Company Revenue
EBITDA—earnings before interest tax depreciation amortisation
Operating Profit
Company's net income
Company's fixed assets
Company's current liabilities
Company's long-term liabilities
Company's long-term creditors
Company's total assets
Company's fixed assets
Company's current assets
Company's total liabilities
Company's PE ratio
Company's Auditors
Company's Financial Advisors
Company's Stock Brokers
Company's Financial PR
Company's Solicitors

The central data entry and management location, 100, containing the Data Repository System, 1, acting as the Master Database is connected via a dedicated link to a slave Database system, 200, located at a different location. The Database system, 200, provides the publicly accessible data as a mirror of the data in the Master Database. The Database system, 200, comprises two systems, 300 and 500, each comprising a Database Processor, 4 and 5, connected to a Database, 2 and 3, which act as slaves to the Master Database. There are two database systems to provide redundancy in the case of the failure of one system. The data entered onto the system by means of the Data Repository System, 1, is loaded onto the two database processors, 4 and 5, which perform a series of analytical calculations to transform the raw data into a form that is useful for the system, e.g. the calculation of complex variables, or data set averages and deviations. The two databases, 2 and 3, are then populated with the plurality of predetermined calculated parameters, and the raw data, for storage. In this way the Master Database is kept offline and this mirroring of data takes place regularly, e.g. daily at night when usage is low. This system enables the Master Database to be continuously updated at the central data entry and management location.

The two database processors, 4 and 5, are further connected to a data processor 6. The Data Processor 6 is used to perform user end requested calculations, for instance it will calculate peer group parameters, which are discussed hereafter. These parameters are stored in the databases, 2 and 3, and are specific to users. Thus user specific parameters such as Peer Group data are generated and stored in the databases, 2 and 3. The Database Processors, 4 and 5, download the data from the Databases, 2 and 3, and transmit the data to the Data Processor, 6.

The Data Processor 6 is connected to two a third system, 500, that comprises two Web Servers, 7 and 8 and a Web Page Data Processor. The system, 500, provides the method of accessing the data in the system, 200, i.e. a web interface. The connection is made across a firewall system for security. Again the existence of two Web Servers is based on the necessity for redundancy in the system. The Data Processor 6, acting as an Application Server to provide data to the Web Servers, 7 and 8, sorts and processes the data into a useable form for the user end of the system, and communicates that data onto the Web Servers, 7 and 8.

The Web Servers, 7 and 8, are both connected to a Web Page Data Store, 9. By communicating with the Web Page Data Store, 9, the Web Servers, 7 and 8, generate web pages that are to be communicated to the client's user interface, based on the data received from the Data Processor, 6.

The Web Servers, 7 and 8, are connected to an IP network, 10, e.g. the internet. A User's Web Browser, 12, on a User's Computer, 11, is also connected to said IP Network, 10. When requested by the User's Web Browser, 12, the Web Servers, 7 and 8, will transmit said generated web pages to the User's Web Browser, 12, via the IP Network, 10. Also the Web Servers, 7 and 8, can transmit Java Script and Java Applets to control the client's user interface, and to generate a number of the web pages on the User's Web Browser, 12. Thus the user interface can be server side generated, client side generated or a mixture of the two.

The User's Web Browser, 12, will then display said web pages in the form of a user interactive display on the User's Computer, 11. The User's Web Browser, 12, can also communicate requests for information back up through the system. This may involve a request for new processed parameters, for example based on a new user selected peer group that the user has set up on his browser. In this scenario a request would be transmitted back to the Data Processor, 6, via the IP network, 10, and one of the Web Servers, 7 or 8. The Data Processor will process the request and transmit the new processed parameters back to the User's Computer in the same manner as the initial parameters were transmitted as discussed above. In this way the Data Processor, 6, generates user specific parameters, e.g. peer groups, and these are stored, along with a User ID, in the databases, 2 and 3, to provide for a level of personalisation when a user accesses the data in the Databases, 2 and 3.

User Interface Description

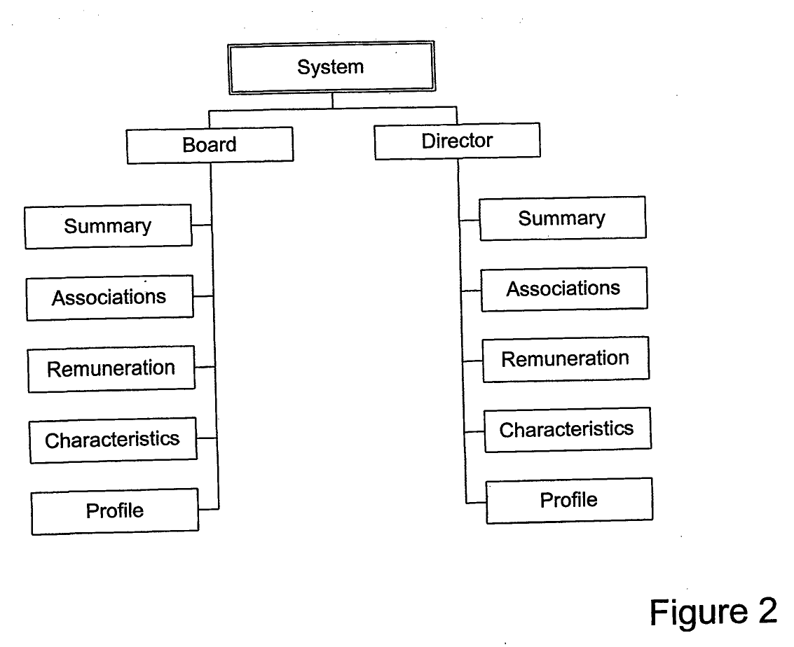

In the embodiment of the present invention, the user interface displayed on the user's web browser is split into two main sections, as shown in FIG. 2: one supplies information regarding one or more Boards and offers comparative analysis of these Boards against other Boards; and the other offers the same functionality at Director level, allowing the comparison of one or more individual Directors against other Directors. In both cases the system is able to display a large number of parameters for any Board and/or Director through a variety of medium, including tabular form and a number of graphical displays.

Data Fields Described by Screen

FIG. 2 shows the main structure of the system's visual user interface information pages. The pages are organised into a hierarchical structure, with each branch containing further levels of detail below it. As mentioned, above, the user must first select either the Board related section or the Director related section. This structure can clearly be seen in FIG. 2 where the Board related pages are on the left hand branch and the Director related pages are on the right hand branch. In each of the two sections the user can select from a list of main topics headings:
Summary
Associations
Remuneration
Characteristics
Profile

Each of these options will display top-level data related to their topic. Some of these topics have further layers of increasingly detailed data, and/or different graphical display methods, in a plurality of related screens and each of the data layers will now be discussed in more detail, initially by looking at the Board related branch and then the Director related branch.

Board Summary

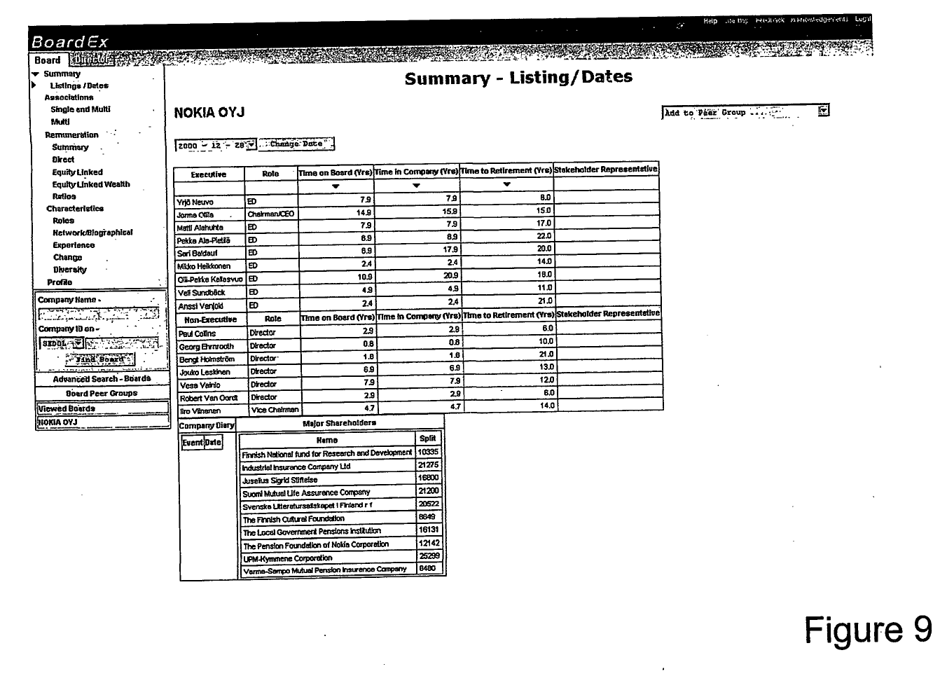

The Board Summary, as shown in FIG. 9, has two themes: firstly it provides a general overview of the members of a Board and displays the following basic information relating to those members:

| | |
|---|---|
| Executive Name- | names of all of the Board Directors |
| Role- | The position held by the Director in the |
| | Company. |
| Time on Board- | The length of time the Director has been |
| | on the Board (in years). |
| Time in Company- | The length of time spent by the Director in |
| | the company (in years). |
| Time to Retirement- | The length of time to retirement, based on |
| | the company's policy retirement age (in |
| | years). |
| Stakeholder Representative- | specific stakeholder group(s) represented |
| | by the Director for example shareholders |
| | representatives, union, employees.. |

The second theme to the Board summary is a list of major shareholders in the company, giving their name and an indication as to the size of their holding.

Board Associations

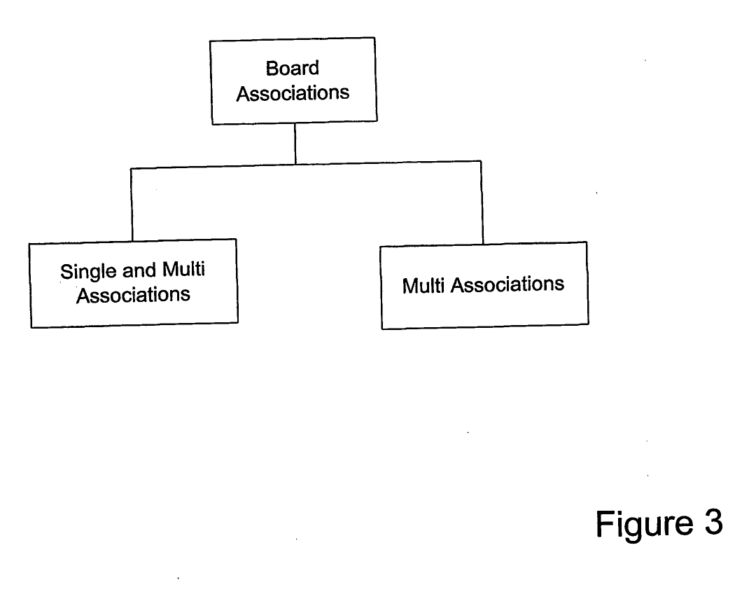

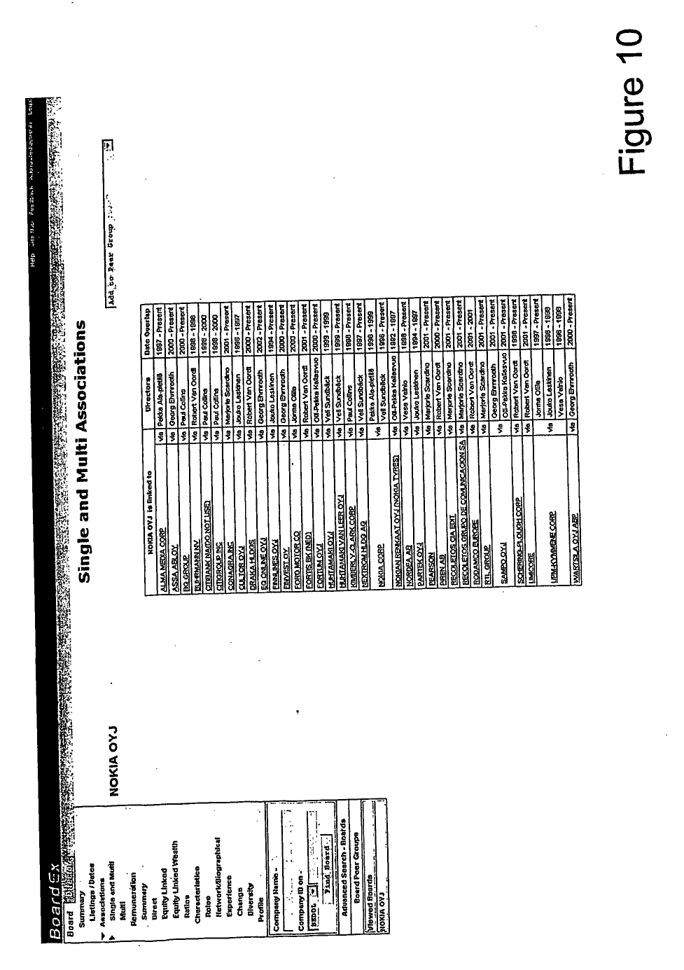

The Board Associations section has two levels beneath it, as shown in FIG. 3, named ‘Single and Multi Associations’, as shown in FIG. 10, and ‘Multi Associations’.

These two pages provide lists of associations that the Directors of a Board have with the Boards of other companies. A ‘Single Association’ occurs when a Director on the Board of one particular company is also serving on the Board of another company, and is the only person from the subject company to have any association with that latter company. A ‘Multi Association’ occurs when two or more Directors from one particular Board both have associations with another particular Board, i.e. two or more Directors are currently serving on that other Board together, or at least one Director has served on another Board at the same time as at least another Director was also serving on that Board, if at least one of them is currently still sitting on that other board. These two features can be seen on FIG. 10, where an example ‘Single Association’ is Georgh Ehrnrooth (bottom row), who is a Director on the Board of Nokia OJY, the subject company, and is also currently a Director on the Board of Wartsila OYJ ABP, and an example of a ‘Multi Association’ is Georg Ehrnrooth and Olli-Pekka Kallasvuo, fifth row from the bottom, who are both on the Board of the Subject company Nokia OYJ and are also both currently on the Board of Sampo OYJ.

Board Remuneration

The Board Remuneration section can be broken down into five main sections:
Remuneration Summary
Direct Remuneration—annual cash based pay.
Equity Linked Remuneration—annual equity linked pay.
Equity Linked Wealth—total equity linked benefits received.
Remuneration Ratios

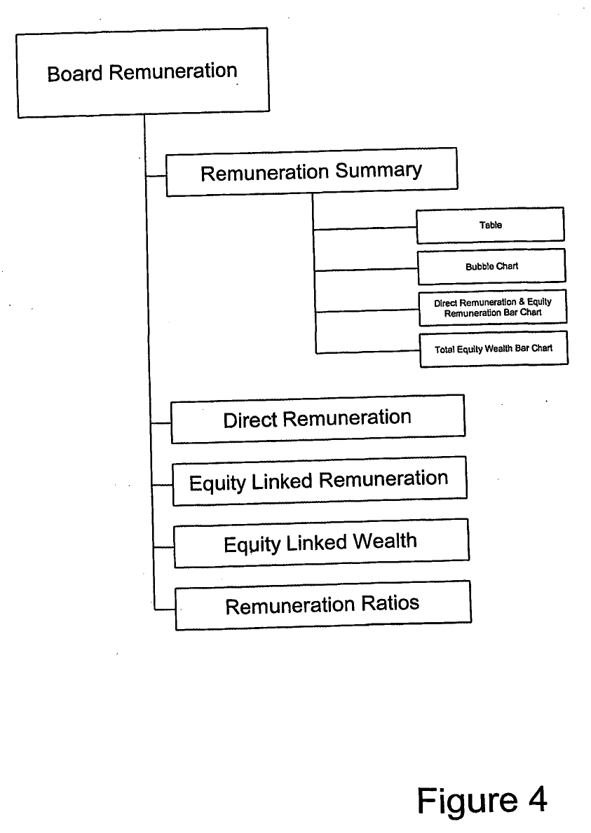

This hierarchy can be seen in FIG. 4. These sections will now be discussed in turn.

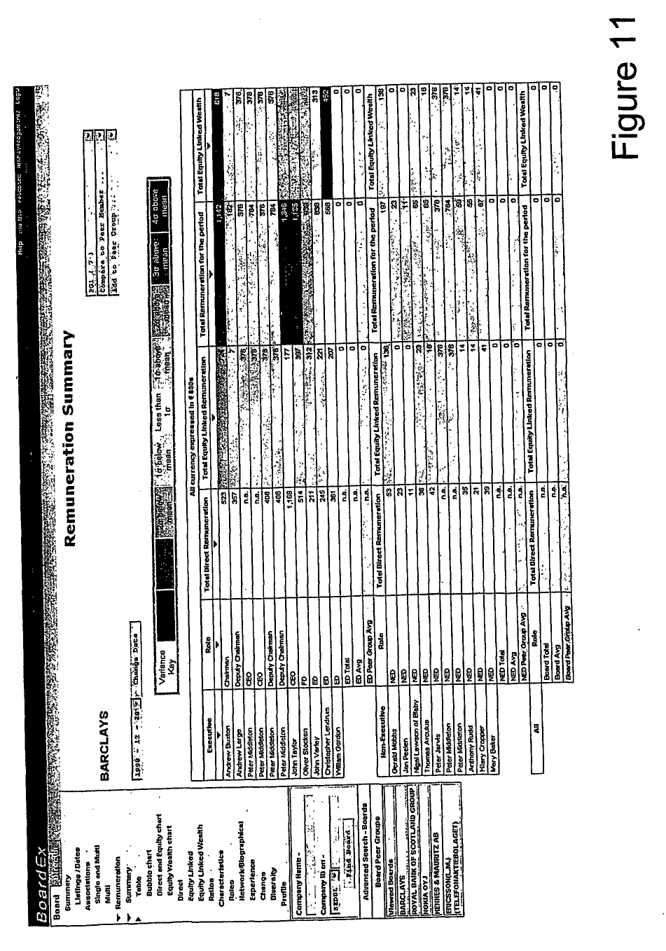

The Remuneration Summary, as shown in FIG. 4, consists of four separate pages, each displaying the summary information in a different manner. The Remuneration Summary Table, as shown in FIG. 11, displays the following parameters:

| | |
|---|---|
| Executive Name- | names of all of the Board |
| | Directors |
| Role- | The position held by the |
| | Director in the Company. |
| Total Direct Remuneration- | the sum of salary, bonus, |
| | pension (defined contribution) |
| | and other non-equity |
| | remuneration. |
| Total Equity Linked Remuneration- | amount of remuneration in the |
| | form of equity, shares, and |
| | options for a particular financial |
| | period. |
| Total Remuneration for the Period- | the sum of the Total Direct |
| | Remuneration and the Total |
| | Equity Linked Remuneration, |
| | each as described above. |
| Total Equity Linked Wealth- | the value of equity held + the |
| | estimated market value of |
| | options held. |

It can also be seen in FIG. 11 that the cells in the table are highlighted in a plurality of different colours, this feature gives an indication of the diversity of the data within the table and will be discussed in more detail hereafter.

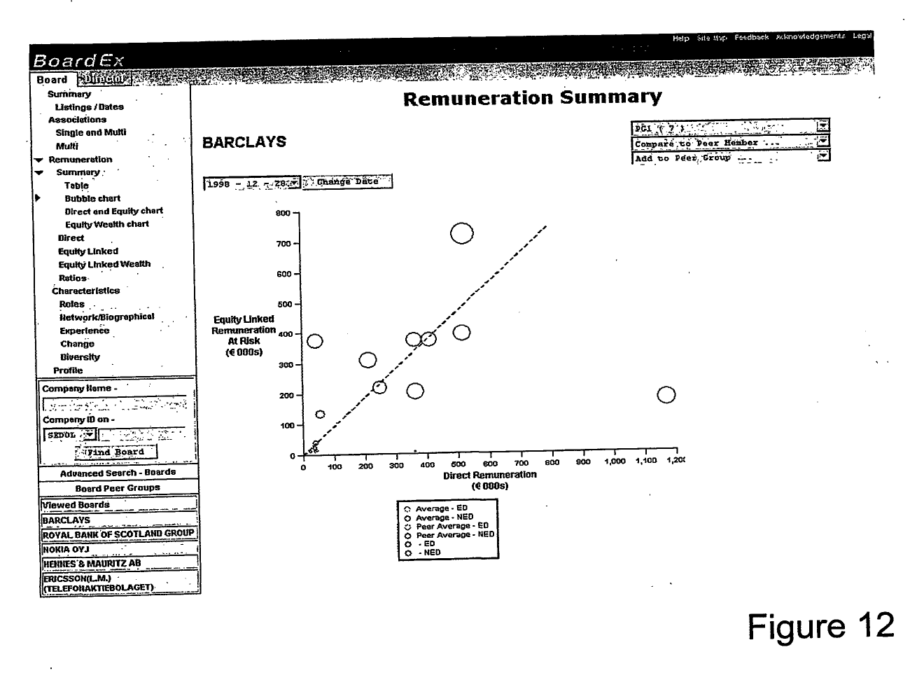

The Remuneration Summary Bubble Chart, as shown in FIG. 12, is a chart that plots the three variables from the Remuneration Summary Table, i.e. the Total Direct Remuneration, the Total Equity Linked Remuneration and the Total Equity Linked Wealth onto the same graph providing a simple a quick analysis method for the data. The x-axis on the graph plots the Direct Remuneration value, and the y-axis plots the Total Equity Linked Remuneration values for each individual Director on the Board. Each data point is then expanded in a circular form, wherein the diameter of each circle is proportional to the value of the Total Equity Linked Wealth of each Director. The circles are colour coded to indicate the difference between different types of data, e.g. executive directors, non-executive directors, averages, etc. . . . It can also be seen in FIG. 12 that various averages and ‘peer group’ averages are plotted, these will discussed hereafter.

The Direct and Equity Remuneration Bar Chart is a standard bar chart, with each Director placed along the x-axis, and the values of their respective Total Direct Remuneration and Total Equity Linked Remuneration for a particular financial period shown as bars, the size of which are relative to a scaled y-axis (for example in £000s of pounds). Lines are also placed on the plot to indicate the values of the Director and peer group averages mentioned above.

The Total Equity Wealth Chart is another bar chart showing each Director along the x-axis with a bar extended upwards relative to the y-axis indicating the relative value of the Total Equity Wealth of each Director. Again, some average values are also indicated.

The Direct Remuneration page provides a breakdown of the Total Direct Remuneration figures given in the Board Remuneration Summary, for a particular financial period. The display is in the form of a table, with format similar to that of the Remuneration Summary in FIG. 11. The parameters displayed are:

| | |
|---|---|
| Executive Name- | names of all of the Board Directors |
| Role- | The position held by the Director in the Company. |
| Salary- | base annual pay |
| Bonus- | payments made in addition to salary |
| Pension- | employer's contribution to the employee's pension |
| | scheme |
| Other- | other ad hoc payments, such as relocation and fringe |
| | benefits |
| Total Direct- | sum of salary, bonus, pension and other income. |

The Equity Linked Remuneration page provides a breakdown of the Total Equity Remuneration figures given in the Board Remuneration Summary, for a particular financial period. The display is in the form of a table, with format similar to that of the Remuneration Summary in FIG. 11. The parameters displayed are:

| | |
|---|---|
| Executive Name- | names of all of the Board |
| | Directors |
| Role- | position each Director holds on |
| | the Board. |
| Value of Equity Awarded- | value of company shares |
| | awarded in the period. |
| LTIP Value- | value of Long Term Incentive |
| | Plan equity contributions. |
| Intrinsic Value of Options Awarded- | the amount by which the current |
| | stock price exceeds the exercise |
| | price of the options. Note: if |
| | the stock price is below the |
| | exercise price, there is no |
| | intrinsic value. |
| Estimated Value of Options Awarded- | Current estimate of the market |
| | value of Options gained, based |
| | on the latest closing stock price |
| | using the Black Scholes option |
| | pricing model, or a modification |
| | thereof. |
| Total Equity Linked Remuneration | the sum of all of the |
| for the Period- | other equity linked |
| | variables in the table, |
| | i.e. the sum of the |
| | variables in this list. |

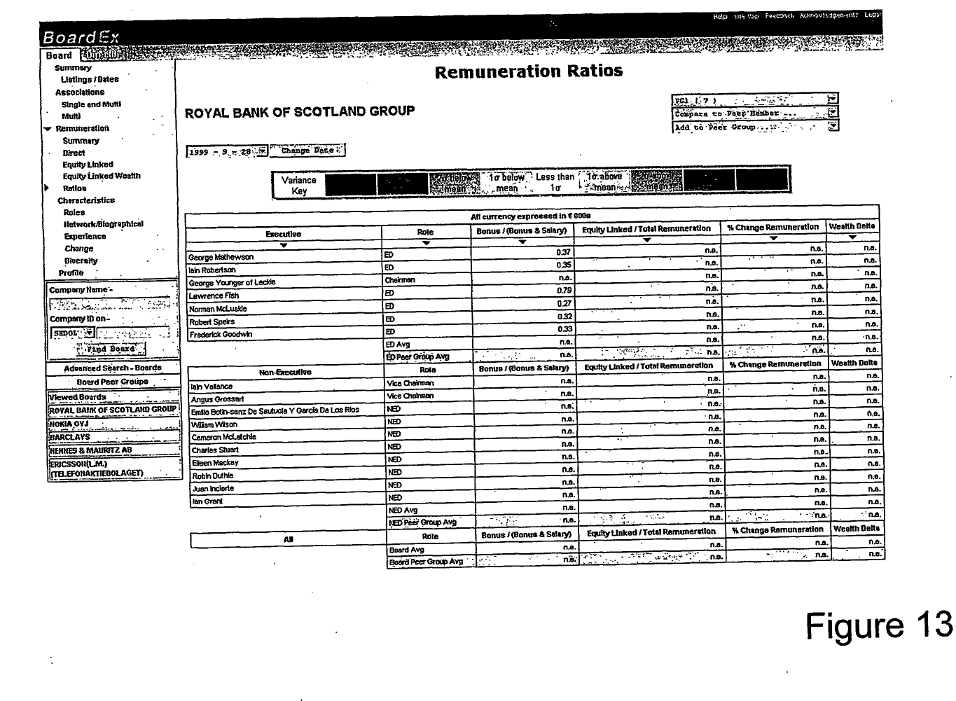

The Remuneration Ratios page is a series of ratios of some of the remuneration parameters mentioned above. The display is in the form of a table, as shown in FIG. 13. The ratios displayed are:

| | |
|---|---|
| Executive Name- | names of all of the Board Directors |
| Role- | The position held by the Director in the Company. |

‘Bonus/(Bonus + Salary)’ Ratio
‘Equity Linked/Total Remuneration’ Ratio

| | |
|---|---|
| % Change | the percentage change of an individual's |
| Remuneration- | remuneration from the one fiscal period to |
| | another, e.g. from the ‘99 financial year to |
| | the ‘00 financial year. |
| Wealth Delta- | the percentage increase in a Directors Wealth due |
| | to a 1% increase in a particular company's share price, |
| | i.e. a measure of a Director's personal financial gain |
| | relative to the company share price success. |

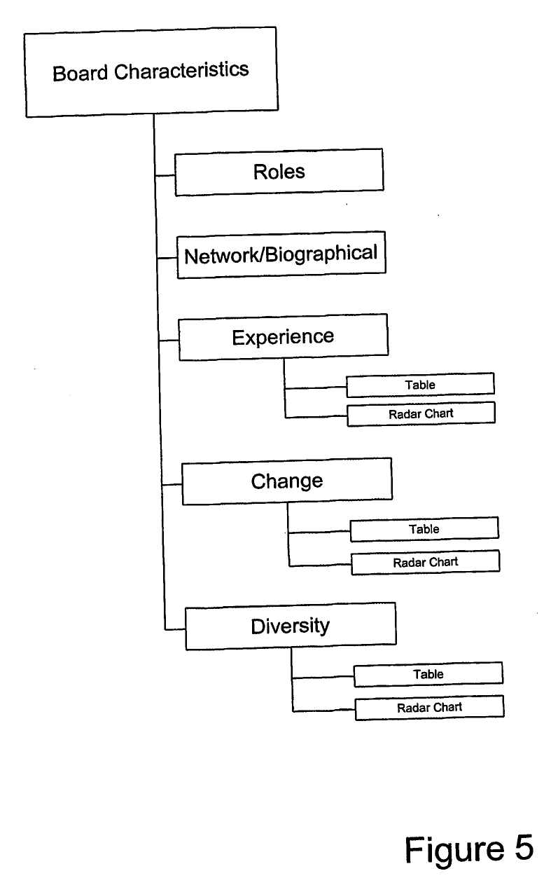

Board Characteristics
The Board Characteristics section can be broken down into five main sections:
Roles
Network/Biographical
Experience
Change
Diversity
   as can be seen in FIG. 5. These sections will now be discussed in turn.

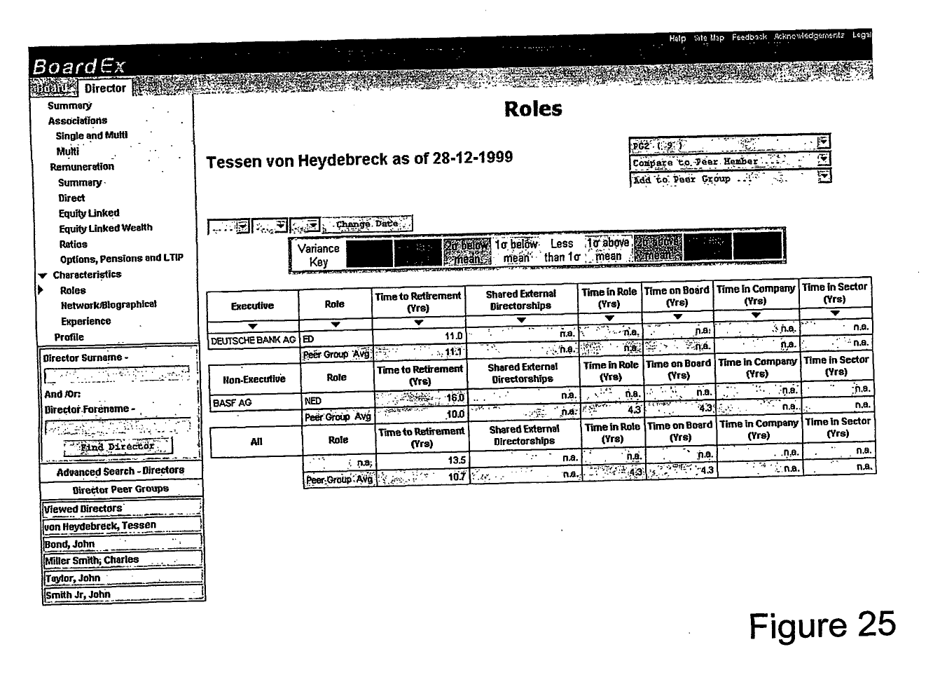

The Board Characteristics ‘Roles’ page provides a breakdown of and parameters relating to the Role that each individual Director has in the company. The page is displayed in a tabular form, similar to that shown in FIG. 25 (FIG. 25 is the Director Characteristics Roles page, but the format is very similar). The parameters displayed on this Roles page are:

| | |
|---|---|
| Executive Name- | names of all of the Board Directors |
| Role- | The position held by the Director in the |
| | Company. |
| Time to Retirement- | The length of time to retirement, based |
| | on the company's policy retirement age |
| | (in years). |
| Shared External Directorships- | The number of Directors on the subject |
| | Board who serve on other boards |
| | together. |
| Time in Role- | number of years the Director has been |
| | in his/her current role on Board. |
| Time in Board- | number of years the Director has been |
| | on the Board, in any role. |
| Time in Company- | number of years under employment |
| | with company. |
| Time in Sector- | number of years the Director has |
| | worked in the market sector. |

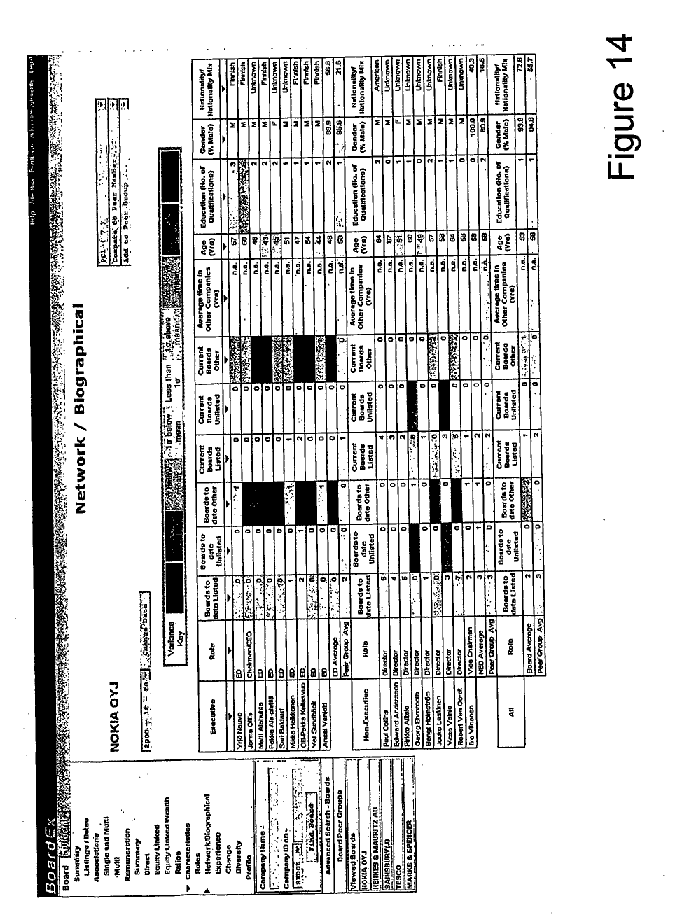

The Board Characteristics ‘Network/Biographical’ page provides a breakdown of and parameters relating to the a Director's current Board level commitments, their history of working Board level commitments, and some basic personal details. The page is displayed in a tabular form, as shown in FIG. 14. The parameters displayed on this Network/Biographical page are:

| | |
|---|---|
| Executive Name- | names of all of the Board Directors. |
| Role- | The position held by the Director in the |
| | Company. |
| Boards to Date Listed- | the total number of Boards of public listed |
| | companies on which the Director has served to |
| | date including current Boards positions. |
| Boards to Date Unlisted- | the total number of Boards of limited |
| | companies on which the Director has served to |
| | date including current Boards positions. |
| Boards to Date Other- | the total number of Other Boards on which the |
| | Director has served to date including current |
| | Boards positions. |
| Current Boards Listed- | the total number of Boards of public listed |
| | companies on which the Director currently |
| | serves. |
| Current Boards Unlisted- | the total number of Boards of limited |
| | companies on which the Director currently |
| | serves. |
| Current Boards Other- | the total number of Other Boards on which the |
| | Director currently serves. |
| Average Time in Other | the average length of time spent by |
| Companies- | individual Directors in companies |
| | other than the subject company (in |
| | years). |
| Age- | the age of the Director |
| Education- | the number of qualifications (degree level, |
| | inc. professional qualifications) held by the |
| | Director. |
| Gender- | Shows either the gender of the Director or |
| | the proportion of the Directors that are male. |
| Nationality- | individual nationalities for each Director, and |
| | a nationality mix ratio for the average values |
| | (where a value of 1 indicates the most |
| | diverse Board possible and a value of 0 |
| | indicates a Board comprising all directors of |
| | one single nationality). |

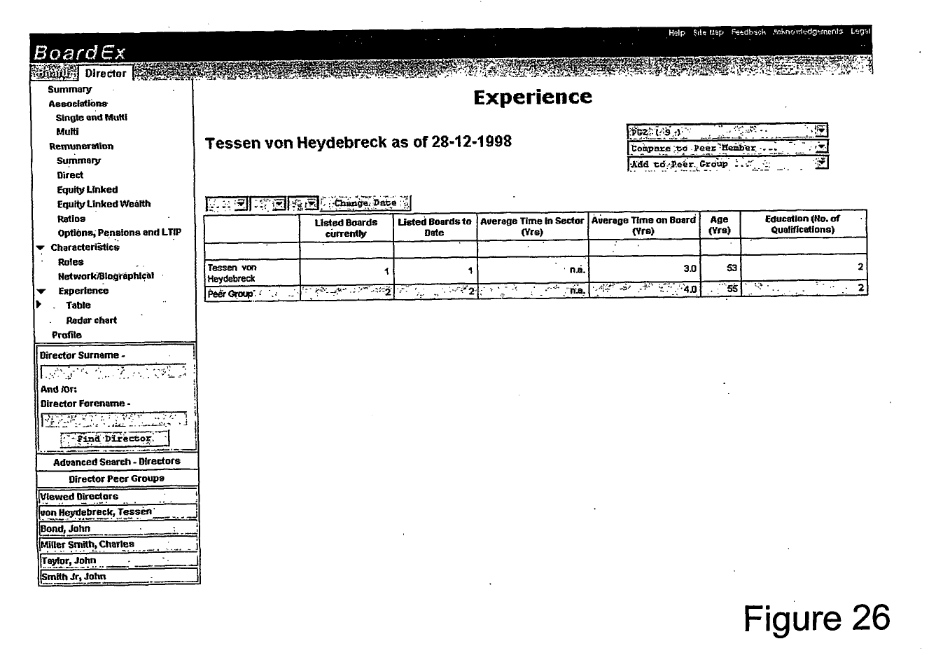

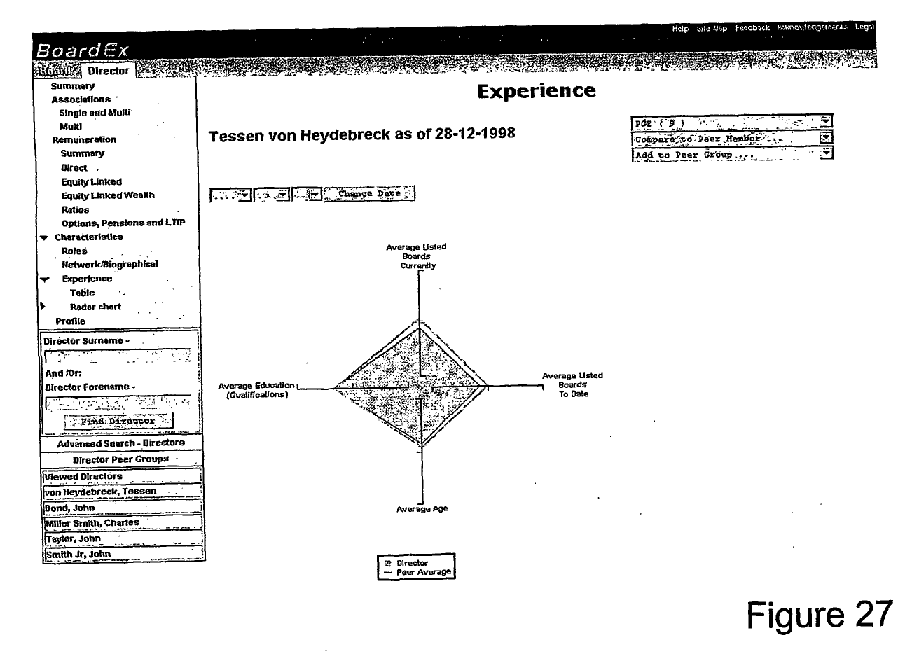

The Board Characteristics ‘Experience’ section consists of two pages, as shown on FIG. 5, a Table and a Radar Chart, providing the same information in two different forms. The pages provide a breakdown of and parameters relating to the Experience of the members of the Board, by mixing together some previously discussed parameters from other pages. The pages are displayed firstly in tabular form, similar to that shown in FIG. 26, and in graphical form similar to that shown in FIG. 27 (FIGS. 26 and 27 are the Director Characteristics Experience pages, but the format is very similar). The parameters displayed on the tabular page are:

| | |
|---|---|
| Executive Level- | these figures are given for the executives |
| | collectively, unlike each individual Director's |
| | statistics as before. This column defines |
| | between Executive Directors, Non-Executive |
| | Directors, and the Board as a whole. |
| Current Boards Listed- | the total number of Boards of public listed |
| | companies on which the Director currently |
| | serves including current Boards positions. |
| Boards to Date Listed- | the total number of Boards of public listed |
| | companies on which the Director has served to |
| | date including current Boards positions. |
| Time in Sector- | number of years Director has worked in the |
| | market sector. |
| Time on Board- | number of years a Director has served on the |
| | Board, in any role. |
| Age- | the age of the Director |
| Education- | the number of qualifications (degree level, inc. |
| | professional qualifications) held by the |
| | Director. |

The Board Characteristics Experience Radar Chart is a multi axis chart that will display the parameters displayed in the Experience Table page on one visual chart. The radar charts will be discussed in more detail hereafter.

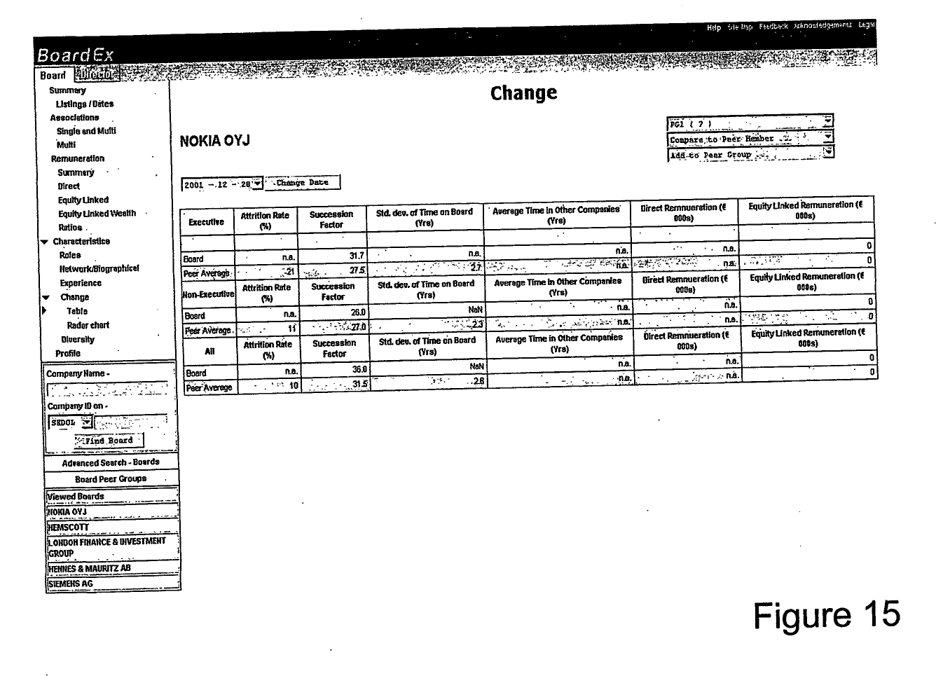

The Board Characteristics ‘Change’ section also consists of two pages, as shown on FIG. 5, a Table and a Radar Chart, providing the same information in two different forms. The pages provide a breakdown of and parameters relating to the stability of the Board, by mixing together some previously discussed parameters from other pages and introducing some new parameters from them. The pages are displayed firstly in tabular form, as shown in FIG. 15, and in graphical form as shown in FIG. 27 (FIG. 27 is the Director Characteristics Experience page, but the format is very similar). The parameters displayed on the tabular page are:

| | |
|---|---|
| Executive Level- | these figures are given for the |
| | executives collectively, unlike |
| | displaying each individual |
| | Director's statistics as in pages |
| | discussed earlier. This column |
| | defines between Executive |
| | Directors, Non-Executive |
| | Directors, and the Board as a |
| | whole. |
| Attrition Rate- | Proportion of Directors who have |
| | left in the previous year. |
| Succession Factor- | the standard deviation of the time |
| | to retirement. This measures the |
| | clustering of Directors and the |
| | proximity of Directors to |
| | retirement. |
| Standard Deviation of Time on | standard deviation from the |
| Board- | average value of the time on the |
| | Board of all members of each |
| | executive group. |
| Average Time in Other | standard deviation from the average |
| Companies- | value of the time in other |
| | companies for all members of each |
| | executive group. |
| Direct Remuneration- | the average Direct Remuneration |
| | for each executive group. |
| Equity Linked Remuneration- | the average Equity Linked |
| | Remuneration for each executive |
| | group. |

The Change Radar Chart, as for the Radar Chart in the previous section, is a multi axis chart that will display the parameters displayed in the Change Table page on one visual chart. These charts will be discussed in more detail hereafter.

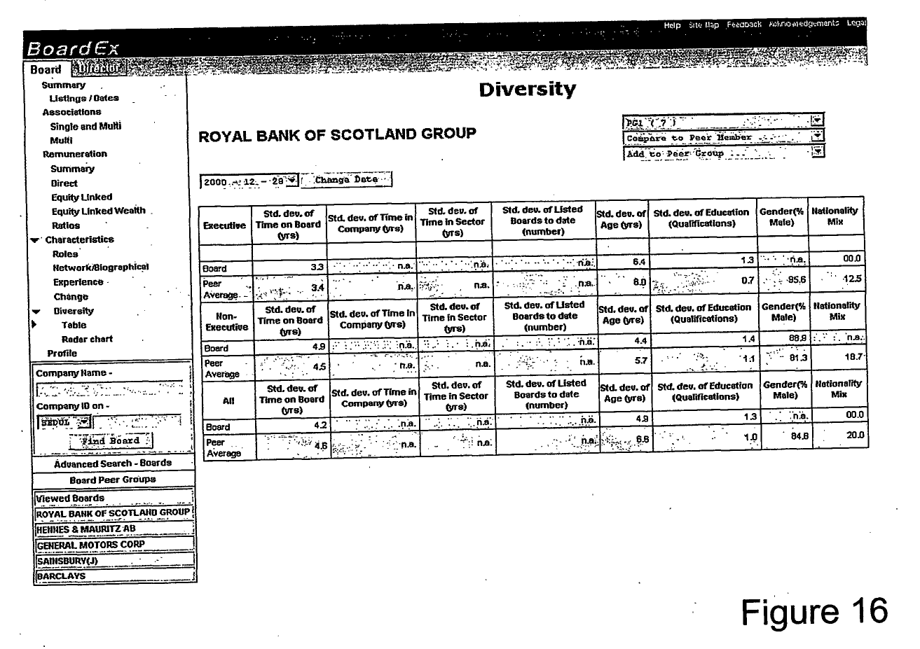

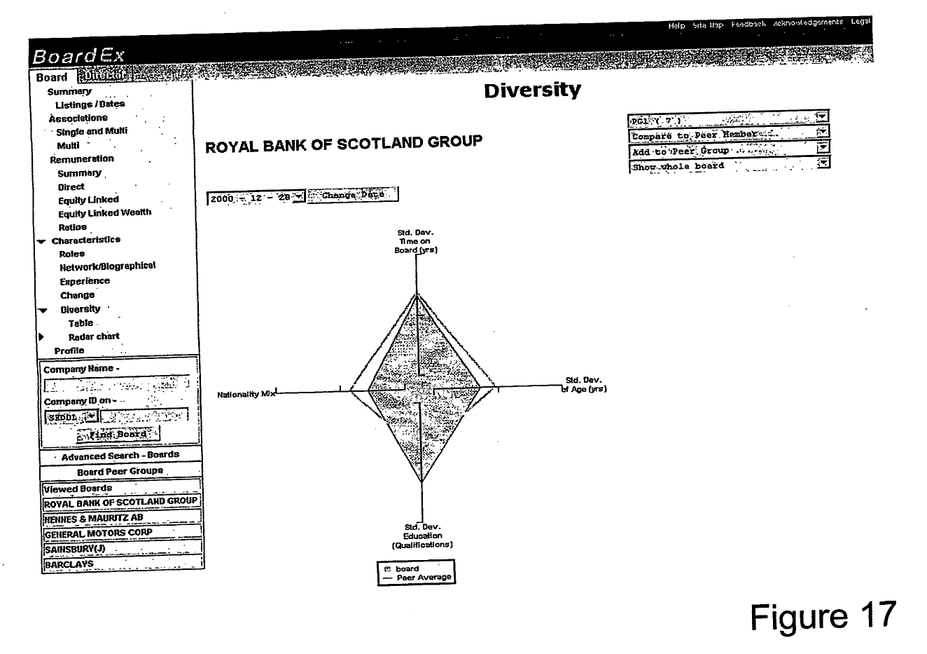

The Board Characteristics ‘Diversity’ section also consists of two pages, as shown on FIG. 5, a Table and a Radar Chart, providing the same information in two different forms. The pages provide a breakdown of and parameters relating to the diversity of the Board, by displaying the diversity of some previously discussed parameters from other pages. The pages are displayed firstly in tabular form, as shown in FIG. 16, and secondly in graphical form as shown in FIG. 17. The parameters displayed on the tabular page are:

| | |
|---|---|
| Executive Level- | these figures are given for the executives collectively, |
| | as with the change statistics above. This column |
| | defines between Executive Directors, Non-Executive |
| | Directors, and the Board as a whole. |
| Standard | standard deviation from the |
| Deviation of | average time served on the Board |
| Time on Board- | by all of the Directors in each |
| | executive group. |
| Standard | standard deviation from the |
| Deviation | average time served in the |
| of Time in | company by all of the |
| Company- | Directors in each executive |
| | group. |
| Standard | standard deviation from the |
| Deviation | average time served in the market |
| of Time in | sector by all of the Directors in |
| Sector- | each executive group. |
| Standard | standard deviation from the |
| Deviation of | average number of Boards |
| Listed Boards | the Directors of each |
| to Date- | executive group have |
| | served on. |
| Standard | standard deviation from the average age of |
| Deviation | the Directors of each executive group. |
| of Age- | |
| Standard | standard deviation from the average |
| Deviation | number of qualifications gained by |
| of Education- | the Directors of each executive |
| | group. |
| Gender- | the proportion of males in each executive group. |
| Nationality- | a nationality mix ratio where a value of 1 indicates |
| | the most nationally diverse Board possible and a value |
| | of 0 indicates a Board comprising all directors of one |
| | single nationality. |

The Diversity Radar Chart, as for the charts in the previous two sections, is a multi axis chart that will display the parameters displayed in the Change Table page on one visual chart, as shown in FIG. 17. These charts will be discussed in more detail hereafter.

Board Profile

The Board Profile provides some general contact information for the subject company, e.g. address, phone number, web site etc. It also provides a short list of some basic financial data for the company, such as the Revenue Figures, Profit & Loss Figures and some key ratios, such as the P/E Ratio. Thirdly it provides a list of advisers to the company, such as it's auditors, solicitors and financial advisors.

Director Summary

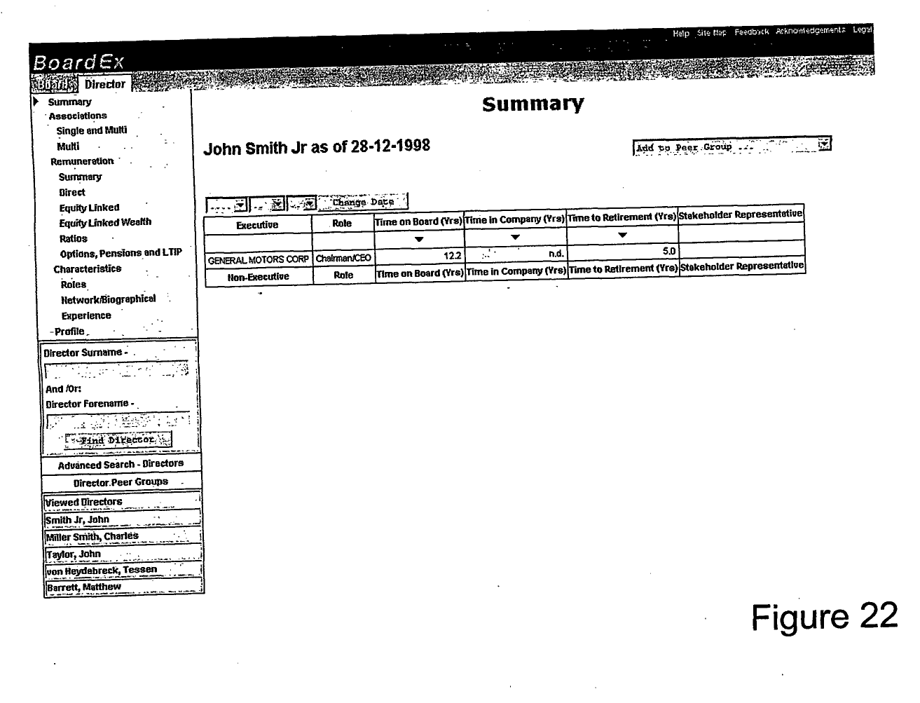

The Director Summary, as shown in FIG. 22, provides a general overview of the positions held by a Director and displays the following basic information relating to those positions:

| | |
|---|---|
| Executive Name- | names of the companies with whom the |
| | Director has a Board level position |
| Role- | The position held by the Director on each |
| | Board. |
| Time on Board- | The length of time the Director has been |
| | on the Board (in years). |
| Time in Company- | The length of time spent by the Director in |
| | the company (in years). |
| Time to Retirement- | The length of time to retirement, based on |
| | the company's policy retirement age (in |
| | years). |
| Stakeholder Representative- | specific stakeholder group(s) represented |
| | by the Director for example shareholders |
| | representatives, union, employees.. |

The second theme to the Director summary is a list of major shareholders in the company, giving their name and an indication as to the size of their holding.

Director Associations

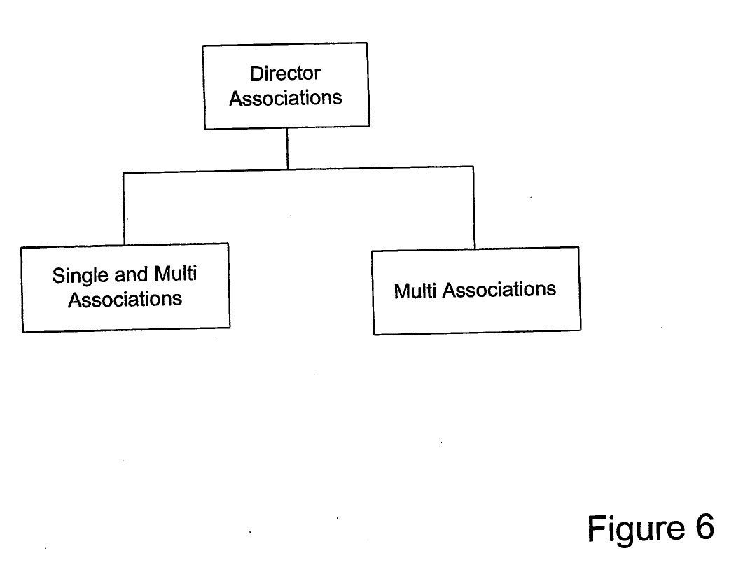

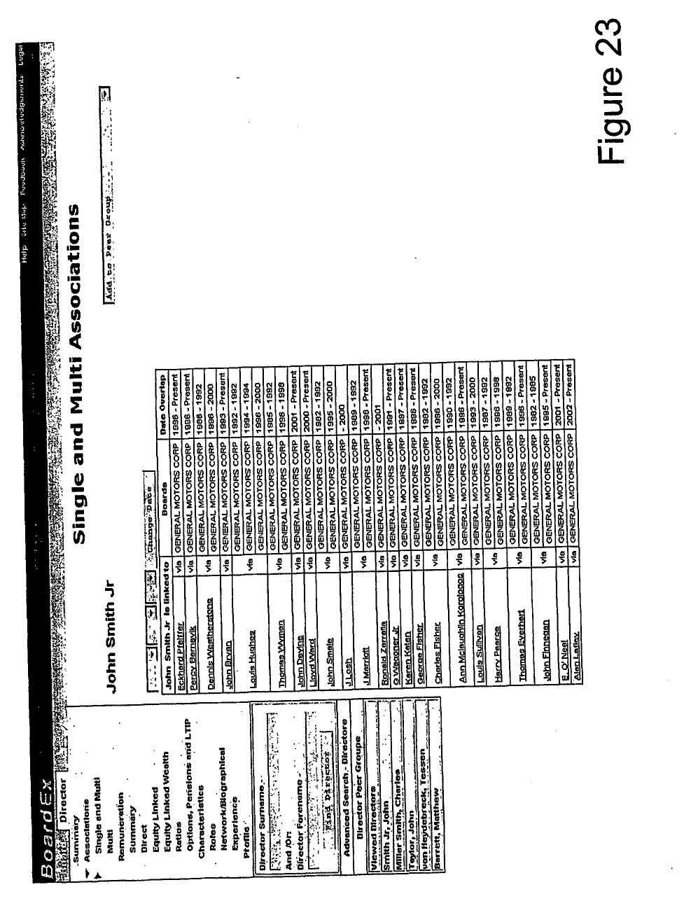

The Director Associations section has two levels beneath it, as shown in FIG. 6, named ‘Single and Multi Associations’, as shown in FIG. 23, and ‘Multi Associations’. These two pages provide lists of associations that the Director has with other Directors through the Boards he/she serves on. A ‘Single Association’ occurs when a Director on the Director of one particular company is also serving on the Director of another company, and is the only person from the subject company to have any association with that latter company. A ‘Multi Association’ occurs when the Director sits on more than one Board with another Director.

Director Remuneration

The Director Remuneration section can be broken down into six main sections:

| Remuneration Summary | |
|---|---|
| Direct Remuneration- | annual cash based pay. |
| Equity Linked Remuneration- | annual equity linked pay. |
| Equity Linked Wealth- | total equity linked benefits received. |
| Remuneration Ratios | |
| Options, Pensions, and LTIP | |

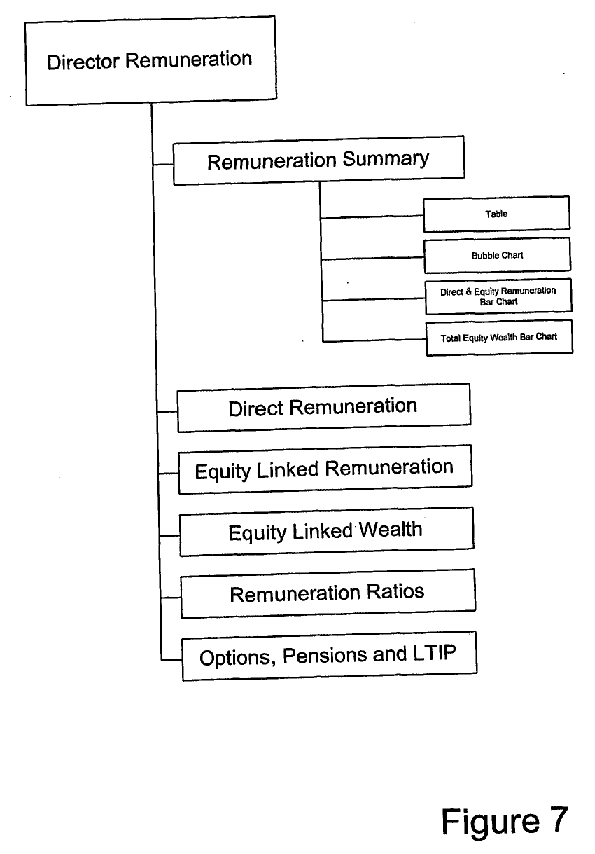

This hierarchy can be seen in FIG. 7. These sections will now be discussed in turn.

The Remuneration Summary, as shown in FIG. 7, consists of four separate pages, each displaying the summary information in a different manner. The Remuneration Summary Table, which is similar to that shown in FIG. 11 (FIG. 11 is the Board Remuneration Summary, but the format is very similar), displays the following parameters:

| | |
|---|---|
| Executive Name- | names of the companies with |
| | whom the Director has a Board |
| | level position |
| Role- | The position held by the |
| | Director on each Board. |
| Total Direct Remuneration- | amount of cash based |
| | remuneration, for a particular |
| | financial period (e.g. a financial |
| | year). |
| Total Equity Linked Remuneration- | amount of remuneration in the |
| | form of equity, shares, and |
| | options for a particular financial |
| | period. |
| Total Remuneration for the Period- | the sum of the Total Direct |
| | Remuneration and the Total |
| | Equity Linked Remuneration, |
| | each as described above. |
| Total Equity Linked Wealth- | the value of equity held + the |
| | estimated market value of |
| | options held. |

As with the Board Remuneration Summary Table in FIG. 11, the Director data tables are highlighted in accordance with the diversity of the data, this will be discussed hereafter.

The Remuneration Summary Bubble Chart, similar to that shown in FIG. 12 (FIG. 12 is the Board Remuneration Summary Bubble Chart, but the format is very similar), is a chart that plots the three variables from the Remuneration Summary Table, i.e. the Total Direct Remuneration, the Total Equity Linked Remuneration and the Total Equity Linked Wealth onto the same graph providing a simple a quick analysis method for the data. The x-axis on the graph plots the Direct Remuneration value, and the y-axis plots the Total Equity Linked Remuneration values for each position that the Director holds. Each data point is then expanded in a circular form, wherein the diameter of each circle is proportional to the value of the Total Equity Linked Wealth of the Director in each position held. The circles are colour coded to indicate the difference between different types of data, e.g. executive Director positions, non-executive Director positions, averages, and ‘peer group’ averages.

The Direct and Equity Remuneration Bar Chart is a standard bar chart, with each Director position placed along the x-axis, and the values of their respective Total Direct Remuneration and Total Equity Linked Remuneration for a particular financial period shown as bars, the size of which are relative to a scaled y-axis (for e.g. in £000s of pounds). Lines are also placed on the plot to indicate the values of the Director and peer group averages mentioned above.

The Total Equity Wealth Chart is another bar chart showing each Director along the x-axis with a bar extended upwards relative to the y-axis indicating the relative value of the Total Equity Wealth of each Director. Again, some average values are also indicated.

The Direct Remuneration page provides a breakdown of the Total Direct Remuneration figures given in the Director Remuneration Summary, for a particular financial period. The display is in the form of a table, with format similar to that of the Board Remuneration Summary in FIG. 11. The parameters displayed are:

| | |
|---|---|
| Executive Name- | names of the companies with whom the Director |
| | has a Board level position |
| Role- | The position held by the Director on each Board. |
| Salary- | base annual pay |
| Bonus- | payments made in addition to salary |
| Pension- | employer's contribution to the employee's pension |
| | scheme |
| Other- | other ad hoc payments, such as relocation and |
| | fringe benefits |
| Total Direct- | sum of salary, bonus, pension and other income. |

The Equity Linked Remuneration page provides a breakdown of the Total Equity Remuneration figures given in the Director Remuneration Summary, for a particular financial period. The display is in the form of a table, with format similar to that of the Board Remuneration Summary in FIG. 11. The parameters displayed are:

| | |
|---|---|
| Executive Name- | names of the companies with |
| | whom the Director has a Board |
| | level position |
| Role- | The position held by the |
| | Director on each Board. |
| Value of Equity Awarded- | value of company shares |
| | awarded in the period. |
| LTIP Value- | value of Long Term Incentive |
| | Plan equity contributions. |
| Intrinsic Value of Options Awarded- | Current Realisable Profit on |
| | Options awarded. |
| Estimated Value of Options Awarded- | Current estimate of the market |
| | value of Options gained, based |
| | on the latest closing stock price |
| | using the Black Scholes option |
| | pricing model. |
| Total Equity Linked Remuneration | the sum of all of the |
| for the Period- | other equity linked |
| | variables in the table, |
| | i.e. the sum of the |
| | variables in this list. |

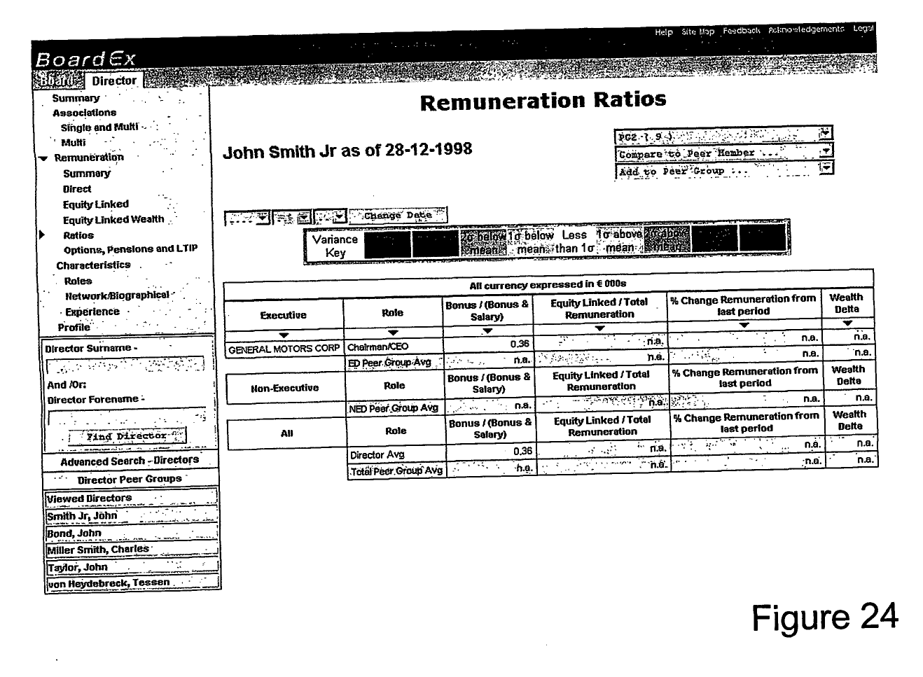

The Remuneration Ratios page is a series of ratios of some of the remuneration parameters mentioned above. The display is in the form of a table, as shown in FIG. 24. The ratios displayed are:

| | |
|---|---|
| Executive Name- | names of the companies with whom the |
| | Director has a Board level position |
| Role- | The position held by the Director on each |
| | Board. |

‘Bonus/(Bonus + Salary)’ Ratio
‘Equity Linked/Total Remuneration’ Ratio

| | |
|---|---|
| % Change Remuneration- | the percentage change of an individual's |
| | remuneration from the one fiscal period to |
| | another, e.g. from the ‘99 financial year to |
| | the ‘00 financial year. |
| Wealth Delta- | the percentage increase in a Directors Wealth |
| | due to a 1% increase in a particular |
| | company's share price, i.e. a measure |
| | of a Director's personal financial gain |
| | relative to the company share price success. |

The Remuneration Options, Pensions and LTIP page provides a revue of these parameters.

Director Characteristics

The Director Characteristics section can be broken down into three main sections:

Roles

Network/Biographical

Experience

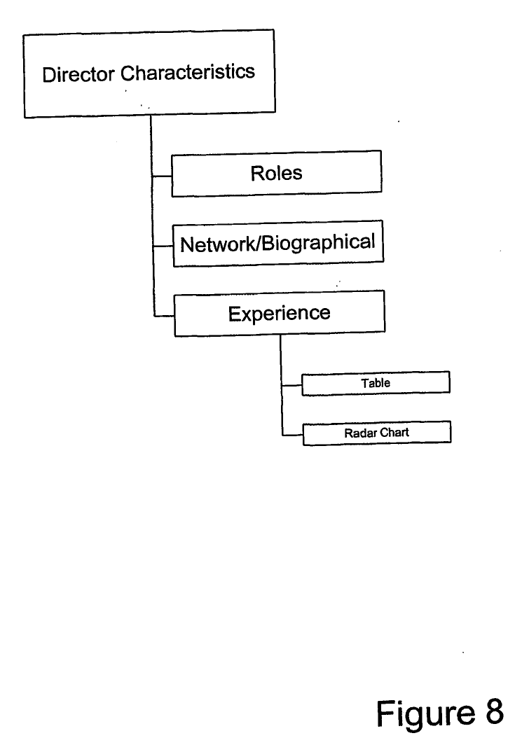

as can be seen in FIG. 8. These sections will now be discussed in turn.

The Director Characteristics ‘Roles’ page provides a breakdown of and parameters relating to each Role held by the Director. The page is displayed in a tabular form, as shown in FIG. 25. The parameters displayed on this Roles page are:

| | |
|---|---|
| Executive Name- | names of the companies with whom the |
| | Director has a Board level position |
| Role- | The position held by the Director on |
| | each Board. |
| Time to Retirement- | The length of time to retirement, based |
| | on the company's policy retirement age |
| | (in years). |
| Shared External Directorships- | The number of Directors who serve on |
| | other Boards with the Director. |
| Time in Role- | number of years the Director has been |
| | on his/her current role on Board. |
| Time on Board- | number of years the Director has been |
| | on the Board, in any role. |
| Time in Company- | number of years under employment |
| | with company. |
| Time in Sector- | number of years the Director has |
| | worked in the market sector. |

The Director Characteristics ‘Network/Biographical’ page provides a breakdown of and parameters relating to the a Director's current Board level commitments, their history of working Board level commitments, and some basic personal details. The page is displayed in a tabular form, similar to the Board Characteristics Network/Biographical page as shown in FIG. 14. The parameters displayed on this Director Network/Biographical page are:

| | |
|---|---|
| Executive Name- | names of the companies with whom the |
| | Director has a Board level position |
| Role- | The position held by the Director on each |
| | Board. |
| Boards to Date Listed- | the total number of Boards of public listed |
| | companies on which the Director has served to |
| | date including current Board positions. |
| Boards to Date Unlisted- | the total number of Boards of limited |
| | companies on which the Director has served to |
| | date including current Board positions. |
| Directors to Date Other- | the total number of Other Boards on which the |
| | Director has served to date including current |
| | Board positions. |
| Current Boards Listed- | the total number of Boards of public listed |
| | companies on which the Director currently |
| | serves. |
| Current Boards Unlisted- | the total number of Boards of limited |
| | companies on which the Director currently |
| | serves. |
| Current Boards Other- | the total number of Other Boards on which the |
| | Director currently serves. |
| Average Time in Other | the average length of time spent by |
| Companies- | individual Directors in companies |
| | other than the subject company (in |
| | years). |
| Age- | the age of the Director |
| Education- | the number of qualifications (degree level, |
| | inc. professional qualifications) held by the |
| | Director. |
| Gender- | Shows the gender of the Director. |
| Nationality- | shows the nationality of the Director. |

The Director Characteristics ‘Experience’ section consists of two pages, as shown on FIG. 8, a Table and a Radar Chart, providing the same information in two different forms. The pages provide a breakdown of and parameters relating to the Experience of the Director, by mixing together some previously discussed parameters from other pages. The pages are displayed firstly in tabular form, similar to that shown in FIG. 26, and in graphical form as shown in FIG. 27. The parameters displayed on the tabular page are:

| | |
|---|---|
| Executive Name- | names of the companies with whom the |
| | Director has a Board level position |
| Current Boards Listed- | the total number of Boards of public listed |
| | companies on which the Director currently |
| | serves including current Board positions. |
| Boards to Date Listed- | the total number of Boards of public listed |
| | companies on which the Director has served to |
| | date including current Board positions. |
| Time in Sector- | number of years Director has worked in the |
| | market sector. |
| Time on Board- | number of years a Director has served on the |
| | Board, in any role. |
| Age- | the age of the Director |
| Education- | the number of qualifications (degree level, inc. |
| | professional qualifications) held by the |
| | Director. |

The Director Characteristics Experience Radar Chart is a multi axis chart that will display the parameters displayed in the Experience Table page on one visual chart. The radar charts will be discussed in more detail hereafter.

Director Profile

The Director Profile provides some general personal information for the Director, e.g. date of birth, nationality etc. It also provides a short CV showing the positions that he/she currently holds and positions that the Director has held in the past, with a brief description of each of those positions.

User Interface

Having looked at the structure of the information pages displayed on the user's web browser, the method by which the user navigates around these pages and how they select which data is to be displayed will now be described.

FIG. 9 shows an example of the general layout of the user interface. The display comprises two parts: a fixed thin navigation pane on the left hand side of the display which displays the list of available information page windows that a user can select, these were discussed above, as well as other features such as a search facility and some historical selection lists, that will be discussed hereafter; the second part of the display comprises a changeable information display pane which can display a series of web style pages that each provide a different set of the actual Board/Director related information pages that are received from the web server. A user can select which page of data he wishes to have displayed in the right hand pane by selecting from the hierarchical list in the left hand navigation pane.

The navigation pane provides a lower level break down of available pages as the user navigates around the system. For instance in FIG. 9 the top level structure of the system, as shown in FIG. 2, is visible, whereas in FIG. 11, where the user has selected the ‘Board Remuneration Summary’ screen, it can be seen that the navigation list has been extended to show the levels below that of the screen which is being displayed, hence allowing the user to access different methods of display for the ‘Board Remuneration Summary’ information; ‘Table’, ‘Bubble Chart’, ‘Direct and Equity Chart’ and ‘Equity Wealth Chart’ in this case.

Once the user has selected either the Board section or the Director section, by clicking on one of the two labelled tabs in the top left hand corner of the screen, they have to next choose a particular Board/Director to be used as the subject of the data. This selection will instruct the system to download all relevant information for that Board/Director to then allow the user to navigate around the different screens in the navigation panel viewing different data sets related to that Board/Director.

This Board/Director selection is conducted by using one of two search systems which are situated in the navigation pane. FIG. 9 shows these search facilities situated below the screen navigation list in the navigation pane on the left hand side of the display. One search option, the first box below the screen navigation list, comprises a manual entry search system which allows the user to enter some data which the system then uses to search the database. Another search option is called the ‘Advanced Search’ and is situated in the box below the manual search data entry boxes, this involves the user defining a search by selecting from a number of parameters in a pre-defined list that the system will use to narrow the search of the database.

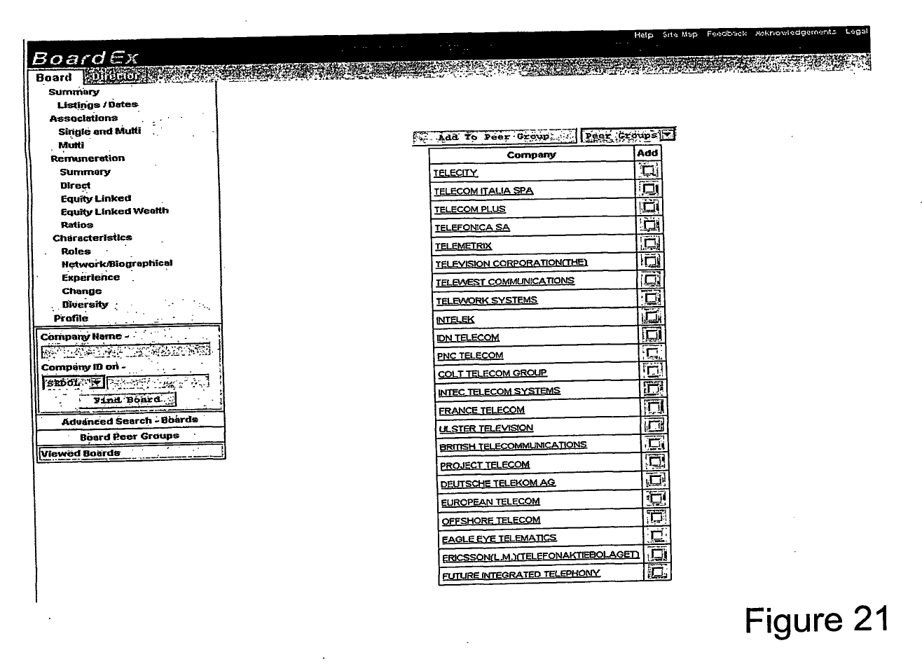

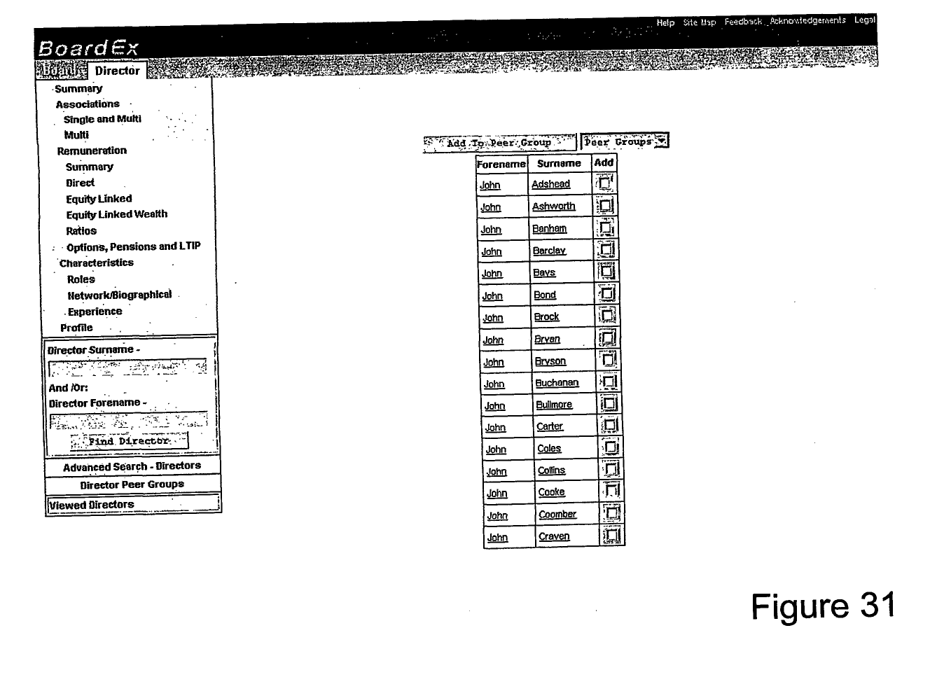

The manual search facility offers two methods of data entry for the search; a user can either input a company/person's name into the ‘Company Name’ text box displayed on the navigation pane; or the user can input another form of company related designation data, such as the SEDOL CODE—a financial markets company ID (the data type can be selected from a drop-down box), by inputting data into the ‘Company ID’ text box on the navigation pane. The system will then conduct a search of the database and produce a search results list such as those shown in FIGS. 21 and 31. The user can then select any Board/Director he wishes to use as the subject of the analysis in the information display pages by clicking on a Board/Director's name from the search results list. The system will then retrieve the parameters for that chosen Board/Director and initially display the ‘Summary’ page for that subject Board/Director, as shown in FIG. 3.

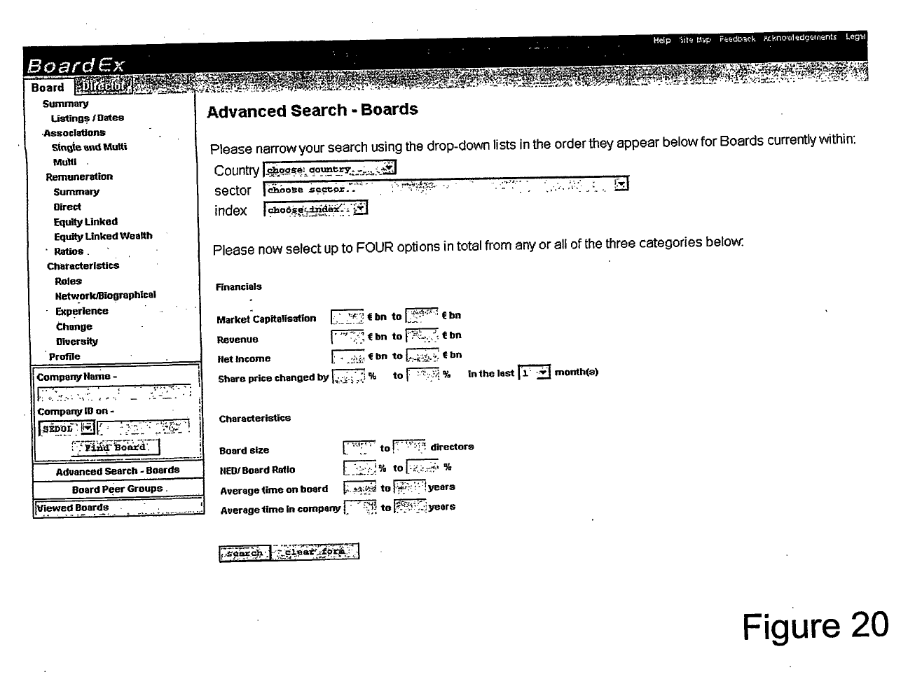

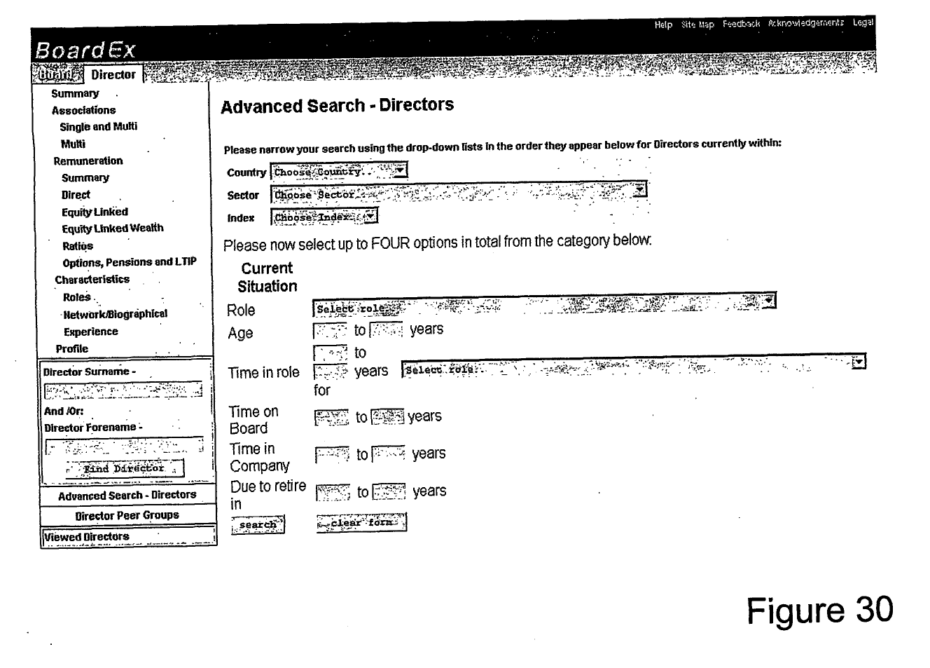

The Advanced Search facility is initiated when the user clicks on the ‘Advanced Search’ button in the navigation pane. A screen such as that in FIG. 20 will be displayed for an advanced Board search, and such as that in FIG. 30 for and advanced Director search. The user will then select at least one of the pre-defined parameters, such as the country or sector of the Board/Director they wish to search for and/or by inputting at least one piece of data into any one of the data entry fields, such as defining a Market Capitalisation of the company of the Board they wish to search for. The system will then conduct a search of the database based on the data entered by the user and produce a search results list, again such as those shown in FIGS. 21 and 31. The user can then select any Board/Director he wishes to use as the subject of the analysis in the information display pages by clicking on a Board/Director's name from the search results list, the system will then retrieve the parameters for that Board/Director and initially display the ‘Summary’ page for that subject Board/Director, as shown in FIG. 9.

A third method of choosing a subject Board/Director to be the subject of the information pages is to select a name from the ‘Viewed Boards’ list at the bottom of the navigation pane. The system will store a list of the last n subjects to have been chosen by the user and display them at the bottom of the navigation pane. This allows the user to easily return to a recent set of displayed data without having to pass through either of the two search methods again.

Once a subject Board/Director has been chosen and its data downloaded and displayed, the name of that Board/Director will be displayed in the top left-hand corner of the display on all of the information pages. When a new Board/Director is chosen, the name displayed will be updated accordingly.

Many of the information pages display the information in tabular form, and there is a marked difference between the style of these tables for the Board section and the Director section in terms of how the data is displayed, these two different styles will now be explained, firstly with reference to Boards.

The rows of the Board related tables of data are split up into three main categories, the top category comprising the Executive Directors, the second category comprising the Non-Executive Directors and the third category comprising All Positions. FIG. 11 shows how this structure is displayed. The top category of FIG. 11 lists the names of the Executive Directors of ‘Barclays’, the second category lists the names of all of the Non-Executive Directors of Barclays, and the bottom category contains the average values for all of the Directors together. It should be noted that this format allows the user to analyse the data for every individual on the selected subject Board, as well as the average value for the ‘executives’ category, an average value for the ‘non-executives’ category and the average value for all members of the Board collectively. Thus, this set-up provides a large amount of segregated and averaged data to allow the user to analyse a detailed view of all aspects of a Board at the same tine.

The Director section display is shown in FIG. 25. It can be seen that the selected Director is Tessen von Heydebreck and that he serves on two Boards, as an Executive Director with Deutsche Bank, and a Non-Executive Director with BASF AG. In a similar manner to the Board tables, these different positions are split in to separate categories. Any Executive positions will be displayed in the top category, and any Non-Executive positions in the second category, with an average for all positions held shown in the bottom category. Hence, all aspects of an individual Director's commitments are displayed at one time, as well as an average for those positions, providing a comprehensive analysis platform without having to look up each position individually.

Peer Groups

One of the features of the embodiment of the present invention are the so called ‘Peer Groups’ that allow the user to compare a selected subject Board/Director with one or more corresponding Boards/Directors. These Peer Groups act as a benchmark with which to compare and contrast different Boards/Directors, they can comprise one single Board/Direct to allow a direct comparison between two particular companies/individual Directors, or they can contain a plurality of different Boards/Directors, grouped for example by sector.

As mentioned above, the tables of data for both the Board and Director sections are separated into three categories, and as well as showing data for the individual Directors of a Board or the individual Positions held by a Director, each of these categories also displays an average value for all data within that category. Below these average values, as can be seen in FIGS. 11 and 25, is displayed an average value for all of the members of a Peer Group, this can be used as a comparative measure for the individual Board members/Director positions, as well as for the average values for each category.

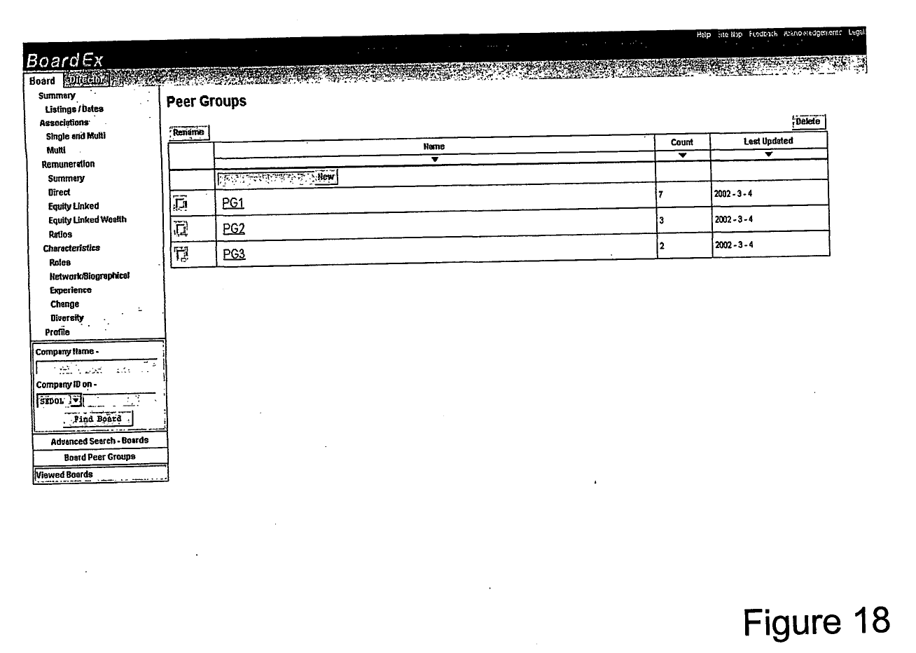

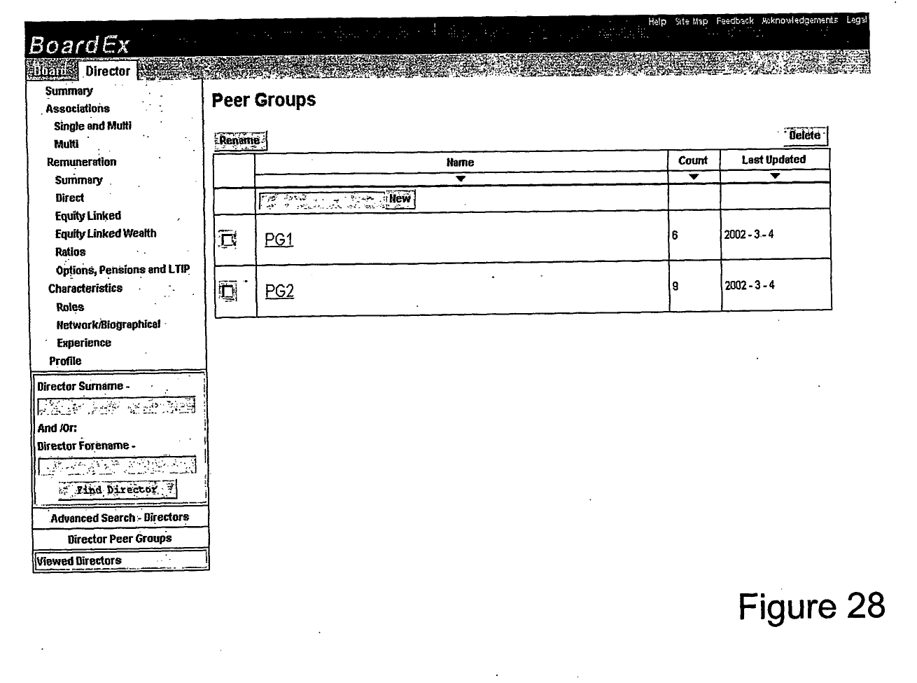

A key function of these Peer Groups is to enable the user to define the constituents of any Peer Group and can select any Peer Group from their records to be used in the comparison. At the bottom of the navigation pane, above the Viewed Boards/Directors section is the Peer Group Button which when selected opens up the Peer Group management screens. These screens work in exactly the same way for the Board sections as for the Director section and will therefore be explained together, with reference to a number of corresponding diagrams. FIGS. 18 and 28 show the first page of the Peer Group management pages. This page displays all of the Peer Groups that have been set up by the user to date. We can see in FIG. 18 that the user has set up three Peer Groups: PG1, PG2 and PG3, and that those Peer Groups contain seven, three and two members respectively. From the Peer Group amendment screen the user is able to view the members of any Peer Group, amend the members of any Peer Group, or set up a new Peer Group.

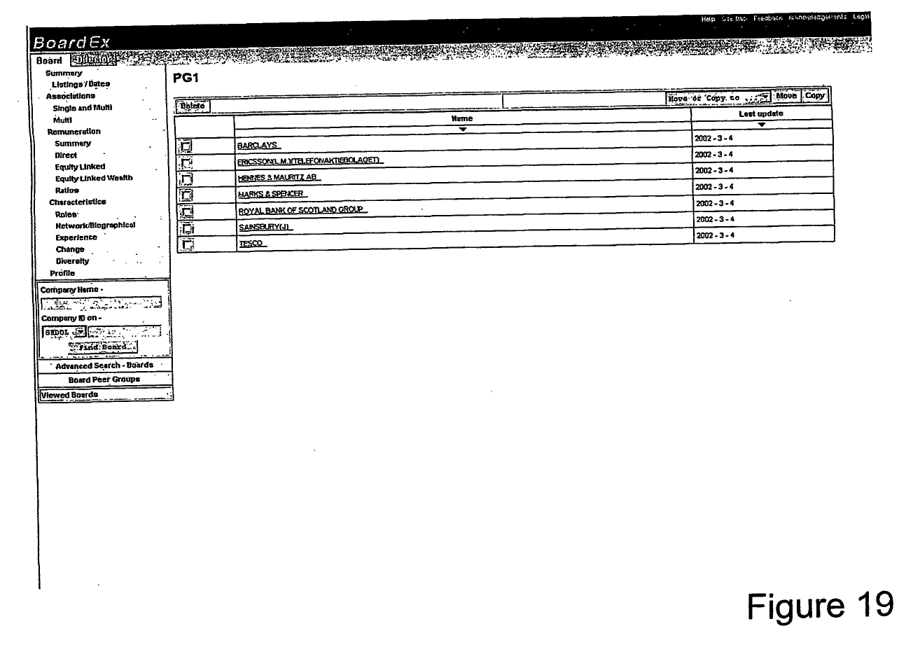

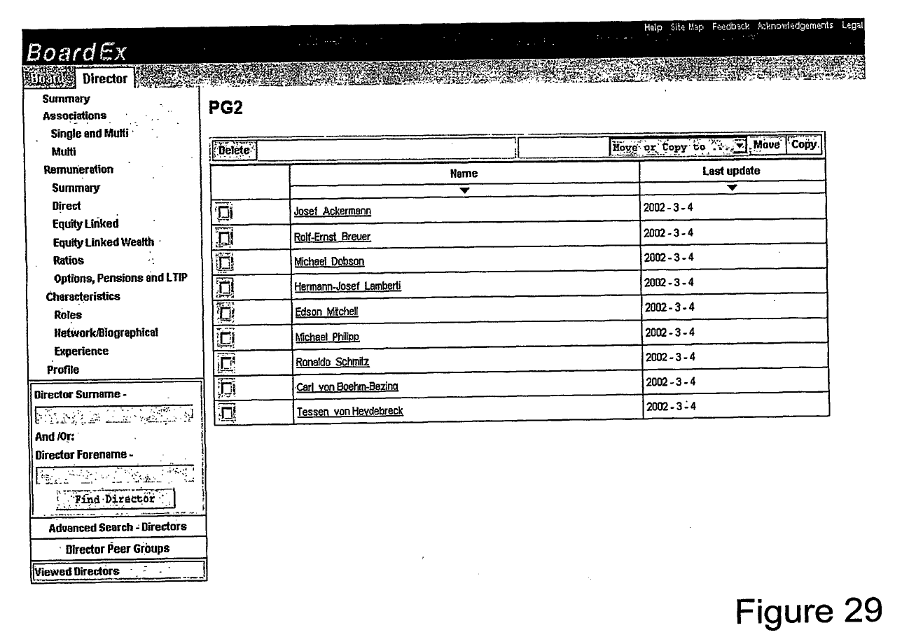

To view the members of a Peer Group, shown in FIGS. 18 and 28, the user simply clicks on the name of one of the Peer Groups and a screen containing a list of Peer Group members is displayed, such as those shown in FIG. 19 for the Board Peer Group PG1 and in FIG. 29 for the Director Peer Group PG2. Hence it can be seen that the Board Peer Group PG1 consists of seven Boards, including those of Barclays and Marks & Spencer, and the average parameter values displayed on a table of data on a Board information screen, for this Peer Group, would be equal to the average value for all of the groups in the Peer Group.

The user can easily amend the members of a Peer Group whilst in the Peer Group members screen, as in FIG. 19 or 29, by adding a new member or deleting an existing Peer Group member, as well as being able to move or copy a member to another Peer Group. To delete a member the user would check the check box to the left of any current Peer Group member and then click on the delete button in the top left hand corner of the screen. To copy or move a member the same process would be used except that having selected a member to copy or move the user would choose another Peer Group from a drop-down menu in the top right corner, once a member and other Peer Group have been chosen the user clicks either the copy or move button and the action is completed.

Adding a new user to a Peer Group is slightly more complicated and requires the use of the two searching tools, manual and advanced, that were discussed earlier. A user can search as described earlier by company name, company ID or by using the advanced search and a search results page is displayed, as in FIGS. 21 and 31. If the Board/Director is present in the search result list, the user will check the check box next to the displayed name and then select a Peer Group from a drop-down menu in the top right hand corner of the screen into which they wish to place Board/Director. Once a subject and Peer Group have been chosen, the user clicks on the ‘Add To Peer Group’ button above the search results list and the action is duly performed.

Setting up a new Peer Group mainly involves a combination of the features that have already been discussed, once the initial naming procedure has been carried out. In the main Peer Group page, FIGS. 18 and 28, the user can set up a shell for a new Peer Group by typing a name into the text box next to the ‘New’ button above the list of current Peer Groups. Once a name has been entered and the ‘New’ button has been selected, the shell is created and the name of the new Peer Group are displayed along with the other current Peer Groups. The user can then enter that new Peer Group's member screen and add new members, or indeed copy/move members from other group's member screen to the new Peer Group.

Once one or more Peer Groups have been set up, the user is able to use the Peer Group comparison facility in one of the main Board/Director information screens. Most of the tabular and graphical screens contain a combination of a series of drop-down menus in the top right hand corner of the screen. These enable the user to perform one of three actions: choose a Peer Group to act as a comparison; choose and individual member of any one Peer Group to act as a comparison, or add the current subject Board/Member to a Peer Group.

When the user selects a Peer Group from the ‘Compare to Peer Group’ drop-down list, the system will display the average value for all members of that Peer Group for all of the parameters in any information table or graph. For instance, in FIG. 14, the Compare to Peer Group display box in the top right hand corner of the screen is indicating that Peer Group PG1 has been selected for the comparison to Nokia OYJ, the subject Board, named in the top left hand corner of the screen. The Peer Group averages in the table refer to the average value of all of the members of Peer Group PG1. If the user wished to compare Nokia against a different Peer Group they are able to select a different Peer Group name from the Compare to Peer Group selection drop down menu.

The user is able to compare the subject Board, Nokia OYJ in the example in FIG. 14, against a particular member of the selected Peer Group, PG1 in this example, by selecting one of the members of PG1 from the ‘Compare to Peer Member’ drop-down list, below the ‘Compare to Peer Group’ list in the display. The user could, for instance, choose ‘Marks & Spencer's’ from the PG1 Peer Group list, this would then display the average values for the Marks & Spencer's Board on the table of data and hence allow the user to compare the Boards of Nokia OYJ with Marks & Spencer's directly.

The third drop-down menu in the top right hand corner of the screen allows the user to add the current subject Board, Nokia OYJ in the example of FIG. 14, to any current Peer Group. The user simply clicks on the drop-down menu and a list of existing Peer Groups is displayed, the user can then select one of these per groups and the subject Board is added to that Peer Group automatically.

The Peer Group system works in exactly the same manner for the Director information screen as explained above for the Board information screens. The only difference being that the Peer Groups are made up of individual Directors and the ‘Compare to Peer Member’ list will offer a list of said individuals to allow the user to compare the subject Director to any one specific other Director.

It should be noted that the Peer Group comparisons are also use in the graphical information pages. For instance their values are plotted on the bubble charts for comparison purposes, as mentioned earlier. Also, they are used as a comparative means on the radar charts, FIG. 17 shows an example of this where the thin line is that of the selected Board, Royal Bank of Scotland, and the shaded area represents the values for the selected Peer Group PG1. Again these pages have the functionality to change the Peer Group, view an individual member of a Peer Group or add the subject Board to a Peer Group.

Colour Coding

Another feature of the embodiment of the current invention, as mentioned earlier, is the highlighting of the cells of the tables of information to visually indicate the diversity of the data. Again the Peer Groups play an important part in this function as the reference point from which the diversity is calculated. FIG. 14 shows a table of data for the Network/Biographical parameters. Displayed above the table is a ‘Variance key’ that indicates the association between the colour of the highlighting of each cell and the measure of variance of the data in the cell, as compared to its corresponding Peer Group average value. The cells are highlight in relation to the number of standard deviations that the data contained therein is away from the average value of the selected Peer Group. If the data is within ±1 standard deviations of the Peer Group average, the cell will not be highlighted. If the cell is between −1 and −2 or +1 and +2 standard deviations of the average of the Peer Group it is highlighted in a light colour, and so on where the highlighting becomes darker with the more standard deviations the data is away from the Peer Group average.

This feature provides easily recognisable information to a user. Patterns and trends can be identified in the data much more easily using this feature. It removes the need for a user to laboriously read every data parameter in the tables in order to analyse the data.

Radar Charts

Another feature of the embodiment of the current invention is the radar charts, and especially the method used to determine the scale of the axes. FIG. 17 shows a Diversity Radar Chart for the Royal Bank of Scotland and Peer Group PG1. This radar chart is the corresponding graphical representation of the data in the Diversity Table in FIG. 16. The first aspect to note is the number of columns of data within the Diversity Table and the corresponding number of axes on the Diversity Chart. The chart will display as many parameters from the table as it has data for. In many cases the Diversity table is fully populated with data and the Diversity Chart will have a potential 8 axes. However, if there is insufficient data available, i.e. there is no data for the subject Board or there is no data for the selected Peer Group, the radar chart is adjusted and the axis related to the parameter with insufficient data is removed and hence not displayed. It can be seen from FIGS. 16 and 17 that there is only sufficient data in four of the parameter columns of the Diversity Table, the Gender column does contain some data but is not fully populated, hence the corresponding Radar Chart only has four axes.

The scaling of the axes is based on a similar method to that of the highlighting mentioned above, in that they are bound by a range of standard deviations. The axes are bound by a range of ±3 standard deviations from the average of a Peer Group. Hence the minimum value of each axis on the Radar Chart equals −3 standard deviations from the average of a Peer Group and the maximum value of each axis equals +3 standard deviations from the average of a Peer Group. In this particular embodiment of the invention the Peer Group used for this scaling is not the user selected Peer Groups, it comprises all of the Boards/Directors that are based in the same country as the subject Board/Director. For example in FIG. 17, the Royal Bank of Scotland is based in the UK, hence the scale of the axes in the corresponding Diversity Chart are ±3 deviations from the average value for all other Boards on the Database that are also based in the UK.

This feature provides a useful method of displaying the data to allow easy analysis by a user. The multi axis plot facilitates comparative analysis of a multitude of parameters related to Boards and/or Board members.

Date Change

Another feature of the embodiment of the invention is the date change facility. On each information display page there is a date in the top left corner, below the subject Board/Director name, as can be seen in FIGS. 16 and 17 for example. The date displayed in the box denotes the point in time to which the information displayed relates. The user is able to change this date, by selecting another date from the drop down menu, hence allowing them a very simple tool to view historical data across a wide date range.

Mouse Over

Another feature of the embodiment of the invention is the ‘mouse-over’ facility. The system displays small information notes next to a mouse pointer as the user moves around the screen to enable the user to quickly understand the functionality of a particular feature on the display.

Additional to this is a mouse-over feature to aid the colour coding of data tables facility discussed above. As a user passes their mouse over a shaded cell in a table of data a small information note is displayed showing the specific value of deviation that the particular parameter has from the Peer Group average value, this feature adds more detail to the colour coding system discussed above, when it is required by the user.

Pre-Defined Peer Groups

In another embodiment of the current invention a plurality of pre-defined Peer Groups are be loaded onto the database. The user is able to use, select, and even amend, these pre-defined Peer Groups in the same way as the current user defined Peer Groups, discussed above. These pre-defined Peer Groups are organised into logical groups, such as by sector or geographic region and allows the user to compare a subject Board/Director against one of these default Peer Groups without having to set-up a Peer Group themselves.

Fantasy Board

In another embodiment of the current invention the Board and Director sections are mixed together and function as one unit displaying data for both individual Directors as well as Boards in the same information tables and on the same information charts. This allows for analysis of Boards against Directors, e.g. a user can set up a ‘fantasy Board’ by setting up a Peer Group of Directors and then compare that fantasy Board against a real Board. Or, in turn, an individual Director can be compared against the average value for a Peer Group of one or more Boards.

Enhanced Board/Member Associations Functionality

In another embodiment of the current invention the Board/Director Associations information pages will not only display links between the members of the subject Board/subject Director and other positions that they may hold, but also associations from a subject Board/Director to a target Board Director, via a plurality of other Boards/Directors Associations. For Example, this will allow the user to input their subject Board/Director and a ‘target’ Board/Director with which they would like to make contact. The system will search the database and display a chain of associations which link the two user selected Boards/Directors together. This display may provide a search result such as:
Board 1 is linked to Board 3 via Mr. A;
Board 3 is linked to Board 5 via Mr. B;
Board 5 is linked to Board 2 via Ms. C;
Where Board 1 is the ‘subject’ Board and Board 2 is the ‘target’ Board.

This functionality allows the user to build networks of Boards and Directors for use in a plurality of business situations.

Company Advisors Associations

In another embodiment of the current invention, the associations functionality is extended to encompass the advisors of companies, a list of which is already provided on the Board Profile information page for each Board. In this embodiment a user is able to conduct a search of Associations based on a particular advisor, i.e. make the advisor the subject of the information and display the associations for that advisor. For example, if a particular company has been in trouble as a result of one of their advisors, a user can conduct a search of the Associations of that advisor to other Boards and the system would display a list of any other Boards that use the same advisor. This is useful, for example in the field of fund management, where an advisor has recently shown weakness whilst acting for one of a Fund Manager's holdings, that fund manager could perform a due diligence check to ascertain if any of his other shareholdings are advised by the same advisor by conducting an Associations search on that advisor.

Board Summary ‘Timeline’

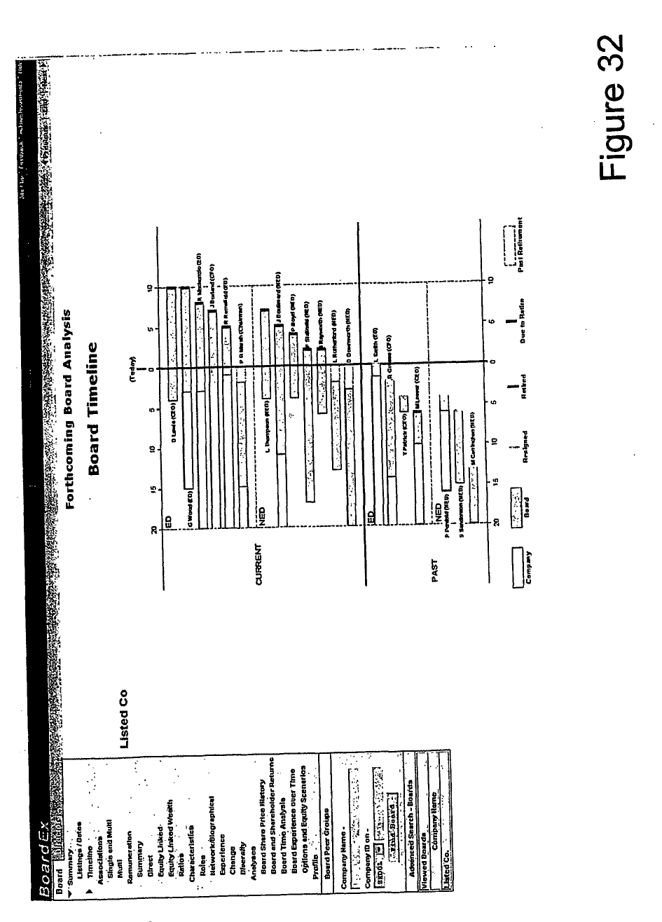

In another embodiment of the current invention a ‘Board Timeline’ chart, as that shown in FIG. 32, is displayed on a second information display page under the ‘Board Summary’ section. This information page displays a bar chart style chart over a discrete time period, pre-set or user defined, showing bars to represent the periods during which each Director has been on the Board, and the position they held, during the said time period.

Director Associtaion ‘Multi’

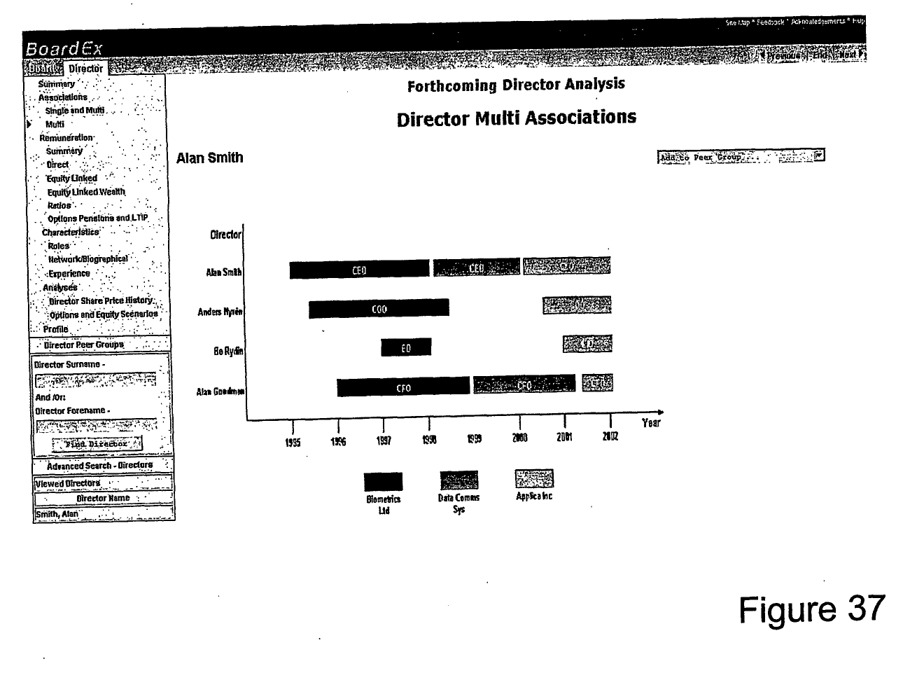

In another embodiment of the current invention a graphical bar chart style plot is displayed to provide a more user friendly method of viewing the Director Multi Associations. An example of this graphical information page is in FIG. 37. The names of each Director are placed along the y-axis of a bar chart, with time (in years) along the x-axis. A bar is then plotted alongside each Director's name for a period in which they held a Director level role, colour coding is used to differentiate between the different companies on which they served. This chart provides a much more user friendly method of reviewing the multi associations of a number of Directors.

Analyses Topic Section

In another embodiment of the current invention the Board and Director sections comprise a sixth main topic heading, in addition to the five existing main sections as discussed above and shown in FIG. 2, named ‘Analyses’. This extra section is added to the user interface navigation pane, as shown in the navigation pane on the left hand side of FIGS. 32 and 37, between the Characteristics and Profiles sections. The two sections contain different sub-layers, and will now be discussed in turn, beginning with the Board section.

Board Analyses

The Board Analyses section can be broken down into five main sections:
Board Share Price History
Board and Shareholder Returns
Board Time Analysis
Board Experience over Time
Options and Equity Scenarios

Each of these sections will now be discussed in turn.

Board Analyses ‘Board Share Price History’, as shown in FIG. 33, displays the share price of the subject company over a discrete time period, pre-set or user-defined, with major Board related corporate actions indicated graphically on top of the chart. For example, if a CEO resigns, a mark will be placed on the graph to indicate the point in time when this occurs. This data can be loaded onto the database automatically or manually, as discussed above, via the analytics data entry method on the Data Repository System (1, FIG. 1) at the Central Data entry Management Location (100, FIG. 1). This facility enables the user to analyse the fluctuations in the company share price relative to such Board related corporate events and allows them to gain a fuller understanding of share price volatility at such points in time. Hence this embodiment offers the user a tool to assess the importance of Board stability for a particular company and hence gain an insight into future share price fluctuations on the announcement of a Board related corporate action.

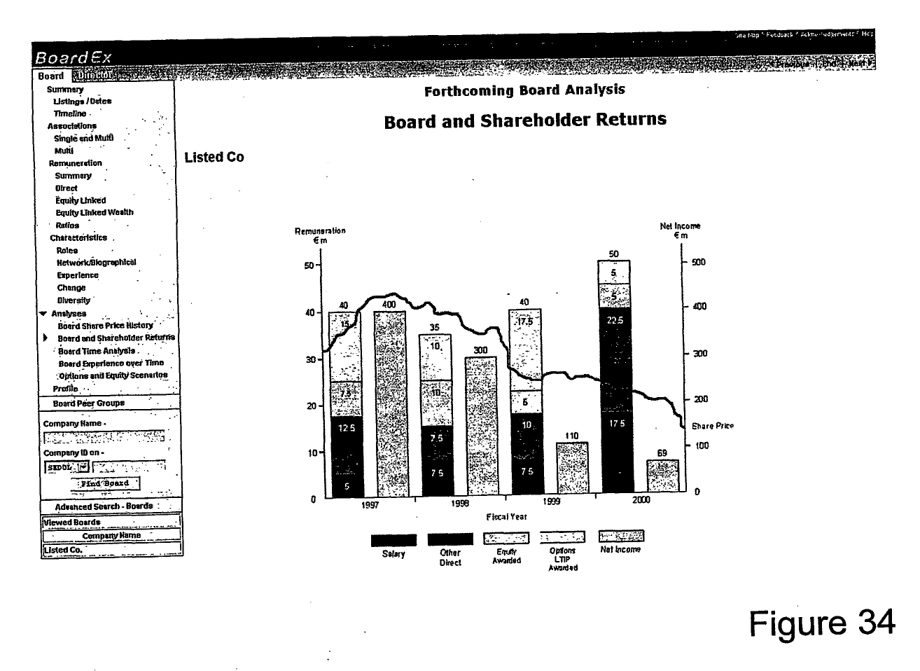

Board Analyses ‘Board and Share Holder Returns’, as shown in FIG. 34, displays a mix of different data types on one graphical display, including Director Direct Remuneration, Director Equity remuneration, Company Income and the Company Share Price. The main element of the graph is a bar chart with two bars for each year along the x-axis, one of these bars displays information relating to the remuneration (further broken down into sections of: salary, other direct, equity, options and LTIP) of the Directors of the Board during that year, the other showing the Net Income of the Company in the same year. On top of the bar chart is displayed the share price of the subject company over the discrete time period, pre-set or user-defined, displayed. This graph enables the user to analyse a number of different features at once, for instance the relationship between company net income and the share price, or that of the Directors income in relation to the share price, plus many more.

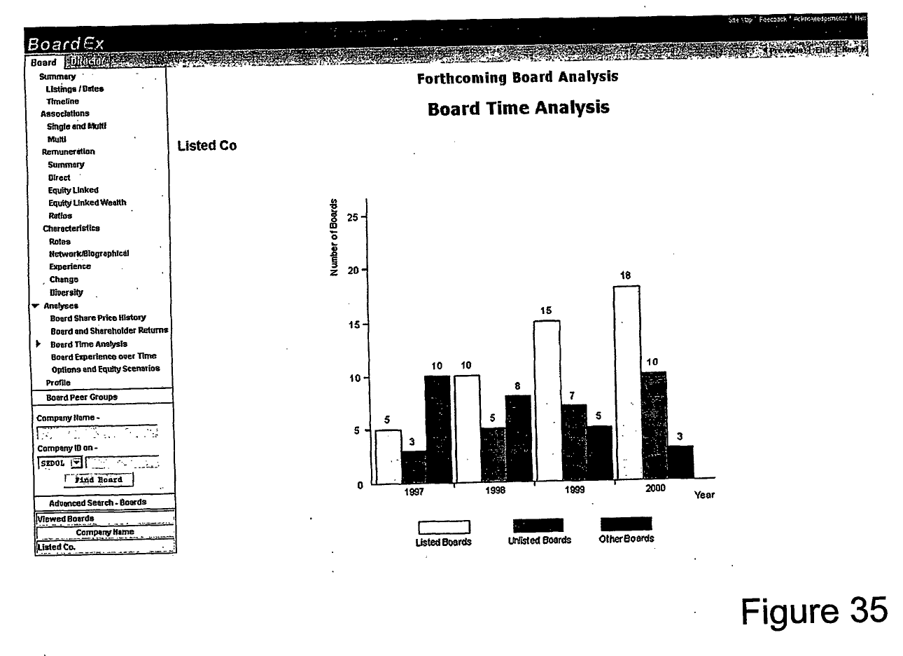

Board Analyses ‘Board Time Analysis’, as shown in FIG. 35, graphically displays a summary of the external commitments of the members of a Board. The graph comprises a bar chart with three bars displayed in each year along the x-axis, each bar to represent board-level positions held on ‘listed’, ‘unlisted’ and ‘other’ boards respectively. The y-axis provides a measure of the average number of those board-level positions held by the members of the subject board during each particular year. This graph is a graphical representation of some of the information given in the Board Characteristics ‘Network/Biographical’ section discussed earlier.

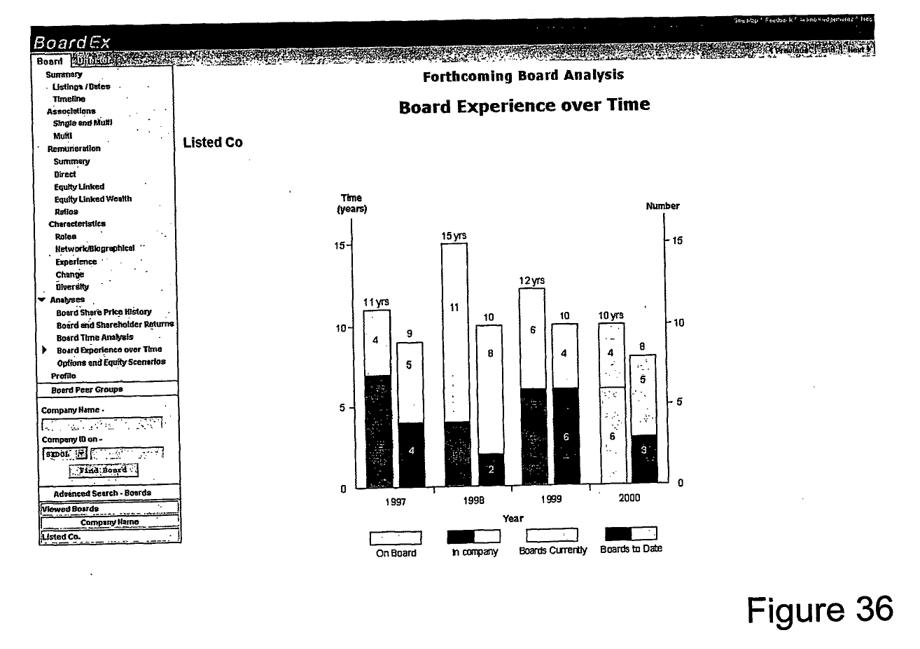

Board Analyses ‘Board Experience over Time’, as shown in FIG. 36, displays a bar chart offering a summary of the experience of the members of the Board on a yearly time basis. Each year plotted along the x-axis contains two bars: the first of which provides an average value, for all of the Board members, of the time spent in the current company, and a measure of how much of that time was spent serving on the Board; the second bar represents the average number, for all the members of the Board, of all the Boards on which they currently serve and all the Boards on which they have served to date. This is another graphical representation related to the experience parameters displayed in the Board Characteristics ‘Experience’ Table information page.

Board Analyses ‘Options and Equity Scenarios’ allows the user to assess the change in the value of the Board held options and equity by running scenarios related to the stock price of a company. The user can enter parameters for an imaginary rise or fall in the price of a stock and the system will calculate and display the effect that this change in stock price would have on the option and equity valuation of the Board of that company.

Director Analyses

The Director Analyses section can be broken down into two main sections:
Director Share Price History
Options and Equity Scenarios

These sections will now be discussed in turn.

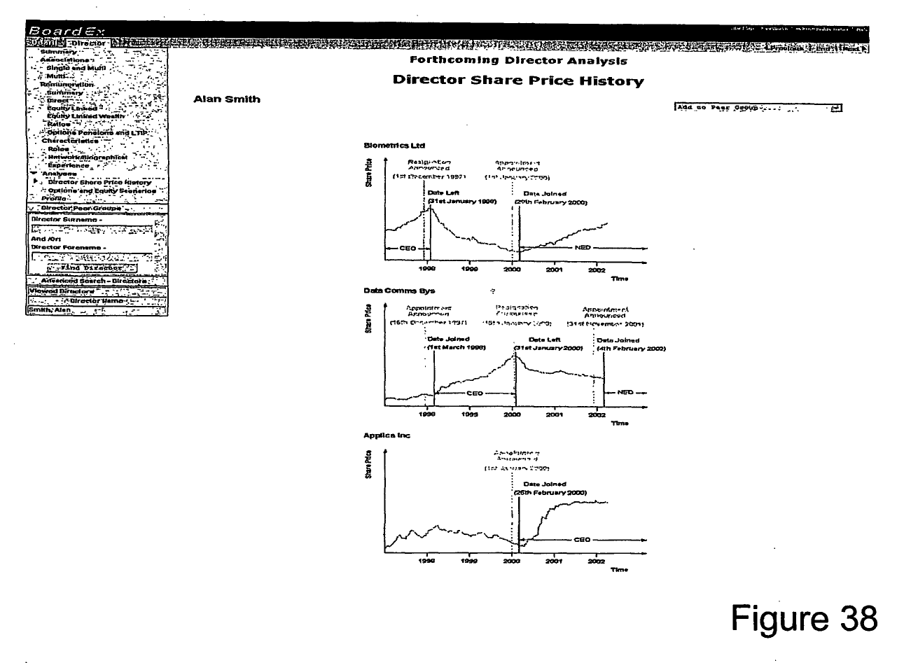

Director Share Price History, as shown in FIG. 38, is a tool to allow the user to assess the impact of a Director on the company share price during each of his Director level positions. A discreet time period, pre-set or user selected, is used and a separate share price chart for each of the companies on whose Board the Director has served during that time are arranged on the same screen. On top of these share price graphs will be displayed time related information relating to when the Director served with each company and the corresponding role which he held on each Board. This data, as with the Board time line analysis data is entered onto the system using the manual analytics software package on the Data Repository System (1, FIG. 1) at the Central Data entry Management Location (100, FIG. 1).

By reviewing the information displayed the user is able to quickly gain an impression of the historical impact of the arrival and departure of the Director in question at each of his past companies, as well as the performance during his/her time on the Board.

Hence, the system is able to provide an indicative historical performance analysis for the Director.

Director Analyses ‘Options and Equity Scenarios’ allows the user to assess the change in the value of the Director held options and equity by running scenarios related to the stock price of a company. The user can enter parameters for an imaginary rise or fall in the price of a stock and the system will calculate and display the effect that this change in stock price would have on the option and equity valuation of a Director of that company.

Peer Group Alerts

In another embodiment of the current invention The Peer Group Alerts section forms part of the Board Peer Groups Section discussed above. These alerts target allow the user to receive targeted corporate action based information about a Board and/or Director Peer Group as follows:

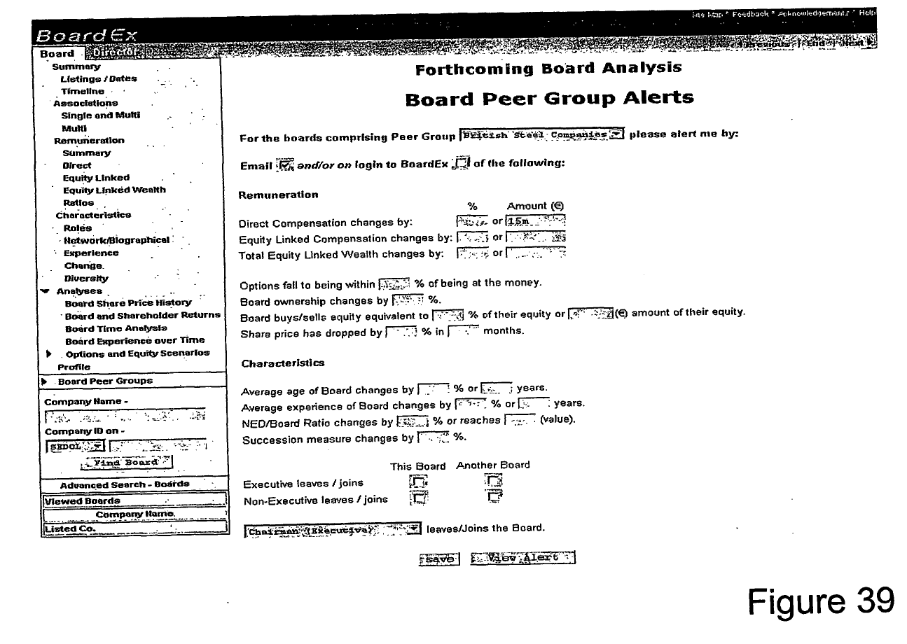

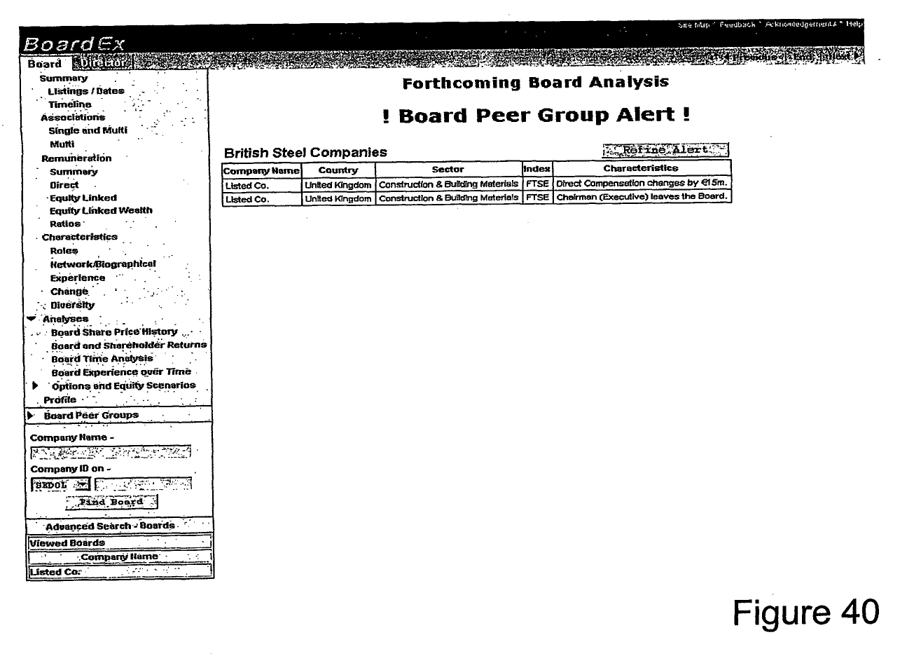

Board Peer Group Alerts allows the user to define a list of criteria for all the members of a Peer Group of Boards, on the action of which an alert will be flagged up to the user indicating the event that takes place. FIG. 39 shows an example of the definitions screen, it can be seen that there is a wide range of Director level and Board level criteria which can be defined for the members of the Peer Group that has been selected from the drop-down at the top of the screen. If any one of the pre-defined variables is met, for instance a Chairman of one of the Boards within the Peer Group leaves, or the average age of the Boards in the Peer Group rises above the selected level, then a message indicating the event will be supplied to the user, either by e-mail or on login depending on the user's preference, as shown in FIG. 40.

This facility allows the user to target the corporate news that they require. Instead of sifting through large quantities of literature to find the information that is useful to them, the user can define the areas in which they are interested, by using the screen shown in FIG. 39, for the Boards in which they are interested, by setting up a Peer Group containing those Boards, as discussed above, and hence receive news that is personally targeted at the user.

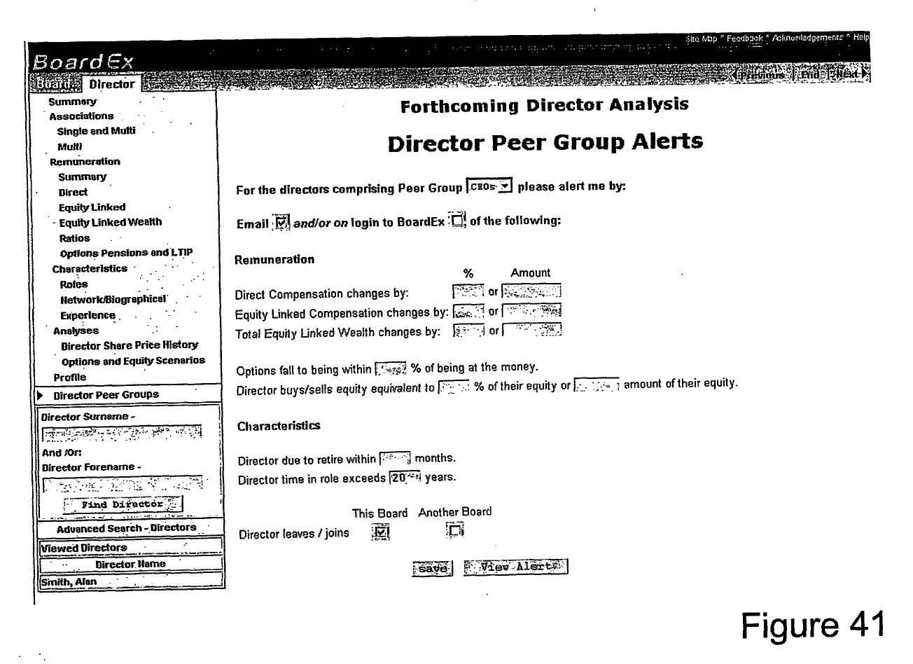

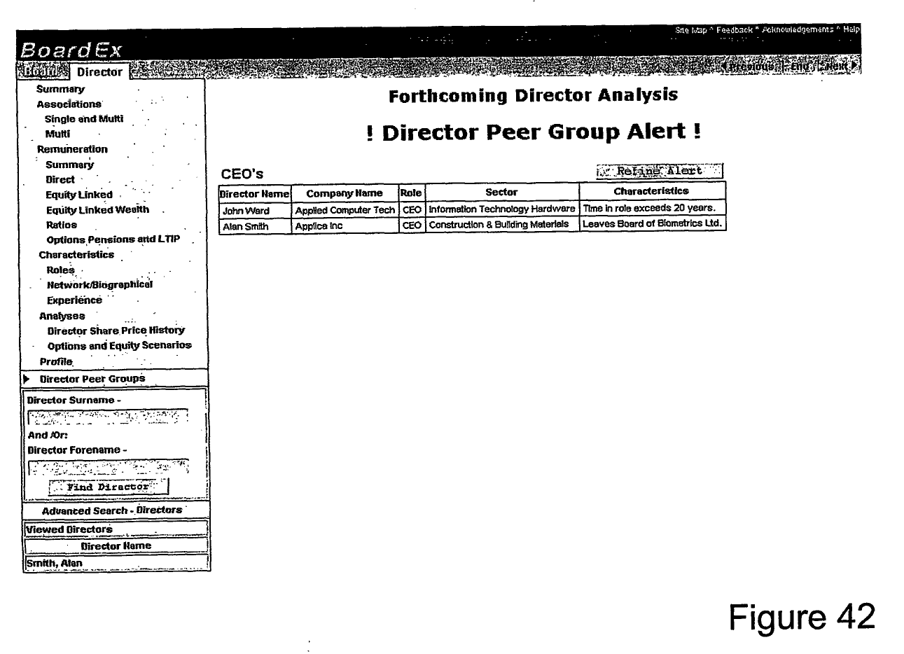

Director Peer Group Alerts allows the user to define a list of criteria for all the members of a Peer Group of Directors, on the action of which an alert is flagged up to the user indicating the event that takes place. FIG. 41 shows an example of the definitions screen, it can be seen that there is a wide range of Director level criteria which can be defined for the members of the Peer Group that has been selected from the drop-down at the top of the screen. If any one of the pre-defined variables is met, for instance a Director within the Peer Group leaves his position, or the average Direct Compensation within the Peer Group rises above the selected level, then a message indicating the event is supplied to the user, either by e-mail or on login depending on the user's preference, as shown in FIG. 42.

This facility allows the user to target the corporate news that they require. Instead of sifting through large quantities of literature to find the information that is useful to them, the user can define the areas in which they are interested, by using the screen shown in FIG. 41, for the Directors in which they are interested, by setting up a Peer Group containing those Directors, as discussed above, and hence receive news that is personally targeted at the user.

Although the present invention has been described hereinbefore with reference to specific embodiments, it will be apparent to a skilled person that modifications lie within the spirit and scope of the present invention.

For example, although the system has been described as being executed on a network, it could be implemented on a single computer or any suitable computer system.

1. A company board data processing system comprising:
a board member store storing parameters related to board members of a plurality of boards organised into boards; and
a user interface generator for generating a user interface displaying said parameters related to board members for a plurality of boards and/or individual board members to allow comparison of boards, at board member level, and/or board members.

2-197. (canceled)

198. A company board data processing system as in claim 1, wherein said user interface generator is adapted to display said parameters for each member of at least one board and/or an average value of one or more of said parameters of said members of at least one board.

199. A company board data processing system as in claim 1, further comprising a board parameter processor for processing parameters for a group of boards or board members to determine processed parameters comprising at least one of one or more parameter totals, one or more parameter averages and one or more parameter deviations, wherein said user interface generator is adapted to generate a user interface to display at least one of said processed parameters for at least one group of boards or board members to allow comparison with at least one board or board member.

200. A company board data processing system as in claim 1, wherein said user interface generator is adapted to generate said user interface to display processed parameters comprising at least one of one or more totals, averages and deviations of said parameters related to a group of board members or boards to allow comparison with at least one board or board member.

201. A company Board data processing system as in claim 1, including a ranking processor for ranking members of a group of boards and/or board members based on relative value of said parameters; wherein
said user interface generator is adapted to generate a user interface to display said parameters of said boards and/or board members of said group to indicate ranking.

202. A company Board data processing system as in claim 199, including a ranking processor for ranking groups of boards and/or board members based on relative value of said processed parameters; wherein
said user interface generator is adapted to generate a user interface to display said processed parameters of said groups of boards and/or board members to indicate ranking.

203. A company data processing system as in claim 199, wherein said group of board members comprises a user selected and/or pre-defined group of boards or board members assigned as a peer group.

204. A company board data processing system as in claim 199, further comprising:
user selector means for receiving a user selection of at least one board and/or board member for inclusion in a peer group;
wherein said group of boards or board members comprises a user selected group of boards or board members assigned as a peer group;
said parameter processor is adapted to process parameters for constituents of a peer group to determine at least one of one or more peer group parameter totals, one or more peer group parameter averages and one or more peer group parameter deviations; and
said user interface generator is adapted to generate a user interface displaying at least one of said processed peer group parameters.

205. A company board data processing system as in claim 204, wherein said user selector means is arranged to receive a user selection of at least one board for comparison with at least one board peer group, and said user interface generator is adapted to generate a user interface to display the parameters related to members of said at least one selected board, to allow the or each board to be the subject of analysis.

206. A company board data processing system as in claim 204, wherein said user interface generator is adapted to generate a user interface to display the parameters related to individual members of said at least one selected board.

207. A company board data processing system as in claim 204, wherein said user selector means is arranged to receive a user selection of at least one board member for comparison with said board member peer group, and said user interface generator is adapted to generate a user interface to display the parameters related to said at least one selected board member, to allow said at least one selected board member to be the subject of analysis.

208. A company board data processing system as in claim 204, further comprising a peer group data store storing data for one or more user selected peer groups;
wherein said user interface generator is adapted to generate a user interface displaying a list of existing peer groups based on said stored peer group data;
said user selector means is arranged to receive a user selection of one or more peer groups from said list; and
said user interface generator is adapted to generate a user interface displaying at least one of said processed parameters for at least one of said selected peer groups.

209. A company board data processing system as in claim 204, further comprising a comparison group amendment means allowing a user to amend the constituents of a peer group.

210. A company board data processing system as in claim 209, wherein said peer group amendment means is adapted to allow a user to copy one or more constituents of a peer group to another peer group.

211. A company board data processing system as in claim 204, further comprising a searching means arranged to allow a user to search for a particular board in the board member store by inputting a specific company or board member name.

212. A company board data processing system as in claim 211, wherein said searching means is adapted to allow a user to search for a particular board in said board member store by selecting one or more parameters from a pre-defined list.

213. A company board data processing system as in claim 1, further comprising:
a store storing pre-defined groups of boards and/or board members comprising peer groups and parameters related to said peer groups;
wherein said user interface generator is adapted to generate a user interface displaying a list of said pre-defined peer groups;
the system further comprising user selector means for receiving a user selection of one or more said pre-defined peer groups from said list;
wherein said user interface generator is adapted to generate a user interface displaying at least one of said stored pre-defined peer group related parameters for said selected pre-defined peer group.

214. A company board data processing system as in claim 213, wherein said stored pre-defined peer group related parameters relate to at least one of one or more group parameter totals, one or more group parameter averages and one or more group parameter deviations.

215. A company board data processing method comprising:
storing parameters related to board members of a plurality of boards organised into boards; and
generating a user interface displaying said parameters related to board members for a plurality of boards and/or individual board members to allow comparison of boards, at board member level, and/or board members.

216. A company board data processing method as in claim 215, wherein said user interface displays said parameters for each member of at least one board and/or an average value of one or more of said parameters of said members of said at least one board.

217. A company board data processing method as in claim 215, further comprising processing parameters for a group of boards or board members to determine at least one of one or more parameter totals, one or more parameter averages and one or more parameter deviations, wherein said user interface displays at least one of said processed parameters for at least one group of boards or board members to allow comparison with at least one board or board member.

218. A company board data processing method as in claim 215, wherein said user interface displays at least one of one or more totals, averages and deviations of said parameters related to a group of board members or boards of to allow comparison with at least one board or board member.

219. A company Board data processing method as in claim 215, including ranking members of a group of boards and/or board members based on relative value of said parameters; wherein
generating a user interface to display said parameters of said boards and/or board members of said group to indicate ranking.

220. A company Board data processing method as in claim 217, including ranking groups of boards and/or board members based on relative value of said processed parameters; wherein
generating a user interface to display said processed parameters of said groups of boards and/or board members to indicate ranking.

221. A company data processing method as in claim 217, wherein said group of boards or board members comprise a user selected and/or pre-defined group of boards or board members assigned as a peer group.

222. A company board data processing method as in claim 217, further comprising:
receiving a user selection of at least one board and/or board member for inclusion in a peer group;
wherein said group of boards or board members comprises a user selected group of boards or board members assigned as a peer group;
parameters for constituents of a peer group are processed to determine at least one of one or more peer group parameter totals, one or more peer group parameter averages and one or more peer group parameter deviations; and
said user interface displays at least one of said processed peer group parameters.

223. A company board data processing method as in claim 222, further comprising receiving a user selection of at least one board for comparison with at least one board peer group, and said user interface displays the parameters related to members of said at least one selected board, to allow the board to be the subject of analysis.

224. A company board data processing method as in claim 222, wherein said user interface displays the parameters related to individual members of said at least one selected board.

225. A company board data processing method as in claim 222, further comprising receiving a user selection of at least one board member for comparison with said board member peer group, and said user interface displays the parameters related to said at least one selected board member, to allow said at least one selected board member to be the subject of analysis.

226. A company board data processing method as in claim 222, further comprising storing data for one or more user selected peer groups;
wherein said user interface displays a list of existing peer groups based on said stored peer group data;
a user selection of one or more peer groups is received from said list; and
said user interface displays at least one of said processed parameters for at least one of said selected peer groups.

227. A company board data processing method as in claim 222, further comprising receiving a user amendment to the constituents of a peer group.

228. A company board data processing method as in claim 227, further comprising receiving a user instruction to copy one or more constituents of a peer group to another peer group.

229. A company board data processing method of claim 222, further comprising receiving a specific company or board member name as an input from a user, and searching for a particular board in the board member store.

230. A company board data processing method as in claim 229, further comprising receiving a user selection of one or more parameters from a pre-defined list, and searching for a particular board in said board member store.

231. A company board data processing method as in claim 215, further comprising storing pre-defined groups of boards and/or board members comprising peer groups and parameters related to said peer groups;
wherein said user interface displays a list of said pre-defined peer groups; further comprising receiving a user selection of one or more said pre-defined peer groups from said list; and
said user interface displays at least one of said stored pre-defined peer group related parameters for said selected pre-defined peer group.

232. A company board data processing method as in claim 231, wherein said stored pre-defined peer group related parameters relate to at least one of one or more group parameter totals, one or more group parameter averages and one or more group parameter deviations.

233. A company board data processing system comprising a program member storing processor implementable instructions; and
a processor for reading and implementing the instructions stored in the program memory;
wherein the instructions stored in the program memory comprise instructions for controlling the processor to implement the method of claim 215.

234. A carrier medium carrying computer readable instructions for controlling the computer to carry out the method of claim 215.

235. A company board data processing system comprising:
a board member store storing parameters related to board members of a plurality of boards;
user selector means for receiving a user selection of at least one board and/or board member for inclusion in a peer group;
a parameter processor for processing parameters for constituents of a peer group to determine at least one of one or more peer group parameter totals, one or more peer group parameter averages and one or more peer group parameter deviations; and
output means for outputting at least one of the processed peer group parameters.

236. A company board data processing system as in claim 235, wherein said user selector means is arranged to receive a user selection of at least one board for comparison with at least one of the board peer groups, and said output means is adapted to output the parameters related to members of said at least one selected board, to allow the or each board to be the subject of analysis.

237. A company board data processing system as in claim 235, wherein said output means is adapted to output the parameters related to individual members of the or each selected board.

238. A company board data processing system as in claim 235, wherein said user selector means is arranged to receive a user selection of at least one board member for comparison with the board member peer group, and said output means is adapted to output the parameters related to said at least one board member, to allow the or each board members to be the subject of analysis.

239. A company board data processing system as in claim 235, further comprising a peer group data store storing data for one or more user selected peer groups; wherein said output means is adapted to output a list of existing peer groups based on said stored peer group data;
said user selector means is arranged to receive a user selection of one or more peer groups from said list; and
said output means is adapted to output at least one of said processed parameters for the selected peer group.

240. A company board data processing system as in claim 235, further comprising a comparison group amendment means allowing a user to amend the constituents of said peer groups.

241. A company board data processing system as in claim 240, wherein said peer group amendment means is adapted to allow a user to copy one or more constituents of a peer group to another peer group.

242. A company board data processing system as in claim 235, further comprising a searching means arranged to allow a user to search for a particular board and/or board member in said board member store by inputting a specific company or board member name.

243. A company board data processing system as in claim 242, wherein said searching means is adapted to allow a user to search for a particular board and/or board member in said board member store by selecting one or more parameters from a pre-defined list.

244. A company board data processing system as in claim 235, further comprising:
a store storing pre-defined groups of boards and/or board members comprising peer groups and parameters related to said peer groups;
wherein said output means is adapted to output a list of said pre-defined peer groups;
said user selector means is arranged to receive a user selection of one or more said pre-defined peer groups from said list; and
said output means is adapted to output at least one of said stored pre-defined peer group related parameters for said selected pre-defined peer group.

245. A company board data processing system as in claim 244, wherein said stored pre-defined peer group related parameters relate to at least one of one or more peer group parameter totals, one or more peer group parameter averages and one or more peer group parameter deviations.

246. A company board data processing method comprising:
storing parameters related to board members of a plurality of boards organised into boards;
receiving a user selection of at least one board and/or board member for inclusion in a peer group;
processing parameters for constituents of a peer group to determine at least one of one or more peer group parameter totals, one or more peer group parameter averages and one or more peer group parameter deviations; and
outputting at least one of said processed peer group parameters.

247. A company board data processing method as in claim 246, further comprising receiving a user selection of one or more boards for comparison with at least one of said board related peer groups, wherein the parameters related to members of said board are output, to allow the board to be the subject of analysis.

248. A company board data processing method as in claim 246, wherein the parameters related to individual members of the or each selected board are output.

249. A company board data processing method as in claim 246, further comprising receiving a user selection of one or more board members for comparison with said board member related peer group, wherein the parameters related to said board members are output, to allow the board members to be the subject of analysis.

250. A company board data processing method as in any one of claim 246, further comprising storing data for one or more user selected peer groups;
outputting a list of existing peer groups based on said stored peer group data; receiving a user selection of one or more peer groups from said list; and
outputting at least one of said processed parameters for the selected peer group.

251. A company board data processing method as in claim 246, further comprising receiving a user amendment to the constituents of said peer groups.

252. A company board data processing method as in claim 251, further comprising receiving a user instruction to copy one or more constituents of a peer group to another peer group.

253. A company board data processing method as in claim 246, further comprising receiving a specific company or board member name as an input from a user, and searching for a particular board and/or board member in said board member store.

254. A company board data processing method as in claim 253, further comprising receiving a user selection of one or more parameters from a pre-defined list, and searching for a particular board and/or board member in said board member store.

255. A company board data processing method as in claim 246, further comprising storing pre-defined groups of boards and/or board members comprising peer groups and parameters related to said peer groups;
outputting a list of said pre-defined peer groups;
receiving a user selection of one or more said pre-defined peer groups from said list; and
outputting at least one of said stored pre-defined peer group related parameters for said selected pre-defined peer group.

256. A company board data processing method as in claim 255, wherein said stored pre-defined peer group related parameters relate to at least one of one or more peer group parameter totals, one or more peer group parameter averages and one or more peer group parameter deviations.

257. A company board data processing system comprising a program member storing processor implementable instructions; and
a processor for reading and implementing the instructions stored in the program memory;
wherein the instructions stored in the program memory comprise instructions for controlling the processor to implement the method of claim 246.

258. A carrier medium carrying computer readable instructions for controlling the computer to carry out the method of claim 246.

259. A company board data processing system comprising:
a store storing pre-defined groups of boards and/or board members comprising peer groups and pre-defined parameters related to said peer groups;
output means for outputting a list of said peer groups; and
a user selector means for receiving a user selection of one or more of said peer groups from said list;
wherein said output means is adapted to output at least one of said pre-defined parameters for the or each selected peer groups.

260. A company board data processing system as in claim 259, wherein said pre-defined parameters relate to at least one of one or more peer group parameter totals, one or more peer group parameter averages and one or more peer group parameter deviations.

261. A company board data processing system as in claim 259, further comprising a parameter processor for processing parameters for constituents of a peer group to determine at least one of one or more peer group parameter totals, one or more peer group parameter averages and/or one or more peer group parameter deviations; wherein said output means is adapted to output any of said processed parameters.

262. A company board data processing system as in claim 259, wherein said store stores parameters related to board members of a plurality of boards organised into boards;
said user selector means is arranged to receive a user selection of one or more said boards for comparison with any said board peer group; and
said output means is adapted to output the board member parameters for each member of said board individually, to allow the board to be the subject of analysis.

263. A company board data processing system as in claim 259, wherein said user selector means is arranged to receive a user selection of at least one board member for comparison with any said board member peer group, said output means is adapted to output the parameters of said at least one board member, to allow the or each board member to be the subject of analysis.

264. A company board data processing system as in claim 259, further comprising a comparison group amendment means allowing a user to amend the constituents of said peer groups.

265. A company board data processing system as in claim 264, wherein said peer group amendment means is adapted to allow a user to copy one or more constituents of one said peer group to another said peer group.

266. A company board data processing method comprising;
storing pre-defined groups of boards and/or board members comprising peer groups and pre-defined parameters related to said peer groups;
outputting a list of said peer groups;
receiving a user selection of one or more of said peer groups from said list; and
outputting at least one of said pre-defined parameters for the or each selected peer groups.

267. A company board data processing method as in claim 266, wherein said pre-defined parameters relate to at least one of one or more peer group parameter totals, one or more peer group parameter averages and one or more peer group parameter deviations.

268. A company board data processing method as in claim 266, further comprising processing parameters for constituents of a peer group to determine at least one of one or more peer group parameter totals, one or more peer group parameter averages and/or one or more peer group parameter deviations; wherein any of said processed parameters are output.

269. A company board data processing method as in claim 266, further comprising storing parameters related to board members of a plurality of boards organised into boards;
receiving a user selection of at least one said board for comparison with any said board peer group; and
outputting the board member parameters for each member of said at least one board individually, to allow the or each board to be the subject of analysis.

270. A company board data processing method as in claim 266, further comprising receiving a user selection of one or more board members for comparison with any said board member peer group, and outputting the parameters of said board members, to allow the board members to be the subject of analysis.

271. A company board data processing method as in claim 266, further comprising receiving a user amendment of the constituents of said peer groups.

272. A company board data processing method as in claim 271, further comprising receiving an instruction from a user to copy one or more constituents of one said peer group to another said peer group.

273. A company board data processing system comprising a program member storing processor implementable instructions; and
a processor for reading and implementing the instructions stored in the program memory;
wherein the instructions stored in the program memory comprise instructions for controlling the processor to implement the method of claim 266.

274. A carrier medium carrying computer readable instructions for controlling the computer to carry out the method of claim 266.

275. A company board data processing system comprising:
a board member store storing board member related parameters for a plurality of board members;
parameter deviation determining means for determining deviations of said board member related parameters from pre-determined parameters; and
a user interface generator for generating a user interface to display at least one of said board member related parameters highlighted in accordance with said determined deviations.

276. A company board data processing system as in claim 275, wherein said user interface generator is arranged to highlight each said board member related parameter in one of a plurality of colours, wherein said colours relate to the relative value of said determined deviations.

277. A company board data processing system as in claim 275, wherein said board member related parameters relate to one or more parameter totals, one or more parameter averages and/or one or more parameter deviations of a plurality of said board members.

278. A company board data processing system as in claim 275, wherein said predetermined parameters relate to a group of said board members, comprising a peer group.

279. A company board data processing system as in claim 278, wherein said predetermined parameters relate to at least one of one or more totals, one or more averages and one or more deviations of the parameters of the members of said peer group.

280. A company board data processing system as in claim 275, further comprising a parameter processor for processing parameters to determine at least one of one or more totals, one or more averages and one or more deviations for said pre-determined parameters; and wherein said user interface generator is adapted to generate said user interface to display said processed parameters.

281. A company board data processing system as in claim 275, wherein said parameter deviation determining means is adapted to determine said deviations as a number of standard deviations by which said board member related parameters differ from said pre-determined parameters.

282. A company board data processing system as in claim 275, wherein said user interface generator is adapted to generate a user interface to display a table of data, comprising a plurality of cells, each cell containing a said board member related parameter or a said pre-determined parameter, wherein said user interface generator is adapted to highlight said cells containing said board member related parameters in accordance with said determined deviation.

283. A company board data processing system as in claim 282, wherein said user interface generator is arranged to highlight each said cell in one of a plurality of colours, wherein said colours relate to the relative value of said determined deviations.

284. A company board data processing system as in claim 275, wherein said pre-determined parameters relate to a user selected and/or pre-defined group of board members arranged into a peer group.

285. A company board data processing system as in claim 284 further comprising:
user selector means for receiving a user selection of at least one board and/or board member for inclusion in a peer group; and
a parameter processor for processing parameters for constituents of a peer group to determine said predetermined parameters as at least one of one or more peer group parameter totals, one or more peer group parameter averages and one or more peer group parameter deviations.

286. A company board data processing system as in claim 285, wherein said user selector means is arranged to receive a user selection of one or more boards for comparison with at least one of said board related peer groups, and said user interface generator is adapted to generate the user interface to display the parameters related to members of said board highlighted in accordance with said determined deviation, to allow the board to be the subject of analysis.

287. A company board data processing system as in claim 285, wherein said user interface generator is adapted to generate a user interface to display the parameters related to individual members of the or each selected board highlighted in accordance with said determined deviation.

288. A company board data processing system as in claim 285, wherein said user selector means is arranged to receive a user selection of at least one board member for comparison with the board member peer group, and said user interface generator is adapted to generate the user interface to display the parameters related to said at least one board member highlighted in accordance with said determined deviations, to allow the or each board member to be the subject of analysis.

289. A company board data processing system as in claim 285, further comprising a peer group data store storing data for one or more user selected peer groups; wherein said user interface generator is adapted to generate a user interface to display a list of existing peer groups based on said stored peer group data;
said user selector means is arranged to receive a user selection of one or more peer groups from said list; and
said user interface generator is adapted to generate the user interface to display at least one of said processed parameters for at least one of said selected peer groups highlighted in accordance with said determined deviations.

290. A company board data processing system as in claim 285, further comprising a comparison group amendment means allowing a user to amend the constituents of a peer group.

291. A company board data processing system as in claim 290, wherein said peer group amendment means is adapted to allow a user to copy one or more constituents of a peer group to another peer group.

292. A company board data processing system as in claim 285, further comprising a searching means arranged to allow a user to search for a particular board in the board member store by inputting a specific company or board member name.

293. A company board data processing system as in claim 292, wherein said searching means is adapted to allow a user to search for a particular board in said board member store by selecting one or more parameters from a pre-defined list.

294. A company board data processing system as in claim 285, further comprising a store storing pre-defined groups of boards and/or board members comprising peer groups and parameters related to said peer groups;
wherein said user interface generator is adapted to generate a user interface to display a list of said pre-defined peer groups;
including per group user selector means arranged to receive a user selection of one or more said pre-defined peer groups from said list;
wherein said user interface generator is adapted to generate the user interface to display at least one of said stored pre-defined peer group related parameters for said selected pre-defined peer group.

295. A company board data processing system as in claim 294, wherein said stored pre-defined peer group related parameters relate to at least one of one or more group parameter totals, one or more group parameter averages and one or more group parameter deviations.

296. A company board data processing method comprising:
storing board member related parameters for a plurality of board members; determining deviations of said board member related parameters from pre-determined parameters; and
generating a user interface to display at least one of said board member related parameters highlighted in accordance with said determined deviations.

297. A company board data processing method as in claim 296, wherein said user interface is generated to highlight each said board member related parameter in one of a plurality of colours, wherein said colours relate to the relative value of said determined deviations.

298. A company board data processing method as in claim 296, wherein said board member related parameters relate to one or more parameter totals, one or more parameter averages and/or one or more parameter deviations of a plurality of said board members.

299. A company board data processing method as in claim 296, wherein said pre-determined parameters relate to a group of said board members, comprising a peer group.

300. A company board data processing method as in claim 299, wherein said pre-determined parameters relate to at least one of one or more totals, one or more averages and one or more deviations of the parameters of the members of said peer group.

301. A company board data processing method as in claim 296, further comprising processing parameters to determine at least one of one or more totals, one or more averages and one or more deviations for said pre-determined parameters; and wherein said user interface displays said processed parameters.

302. A company board data processing method as in claim 296, wherein said determined deviations comprise a number of standard deviations by which said board member related parameters differ from said pre-determined parameters.

303. A company board data processing method as in claim 296, wherein said user interface displays a table of data comprising a plurality of cells, each cell containing a said board member related parameter or a said pre-determined parameter, said cells containing said board member related parameters being highlighted in accordance with said determined deviation.

304. A company board data processing method as in claim 303, wherein said user interface highlights each said cell in one of a plurality of colours, wherein said colours relate to the relative value of said determined deviations.

305. A company board data processing method as in claim 296 wherein said pre-determined parameters relate to a user selected and/or pre-defined group of board members arranged into a peer group.

306. A company board data processing method as in claim 305, further comprising:
receiving a user selection of at least one board and/or board member for inclusion in a peer group; and
processing parameters for constituents of a peer group to determine said predetermined parameters as at least one of one or more peer group parameter totals, one or more peer group parameter averages and one or more peer group parameter deviations.

307. A company board data processing method as in claim 306, wherein a user selection of one or more boards is received for comparison with at least one of said board related peer groups, and said user interface displays the parameters related to members of said board highlighted in accordance with said determined deviation, to allow the board to be the subject of analysis.

308. A company board data processing method as in claim 306, wherein said user interface displays the parameters related to individual members of the or each selected board highlighted in accordance with said determined deviation.

309. A company board data processing method as in claim 306, wherein a user selection of at least one board member is received for comparison with the board member peer group, and said user interface displays the parameters related to said at least one board member highlighted in accordance with said determined deviations, to allow the or each board member to be the subject of analysis.

310. A company board data processing method as in claim 306, further comprising storing data for one or more user selected peer groups in a peer group data store;
wherein said user interface displays a list of existing peer groups based on said stored peer group data;
a user selection of one or more peer groups from said list is received; and
said user interface displays at least one of said processed parameters for at least one of said selected peer groups highlighted in accordance with said determined deviations.

311. A company board data processing method as in claim 306, further comprising receiving a user amendment of the constituents of a peer group.

312. A company board data processing method as in claim 311, wherein an instruction is received from a user to copy one or more constituents of a peer group to another peer group.

313. A company board data processing method as in claim 306, further comprising receiving a specific company or board member name from a user to search for a particular board in the board member store.

314. A company board data processing method as in claim 313, wherein a user selection of one or more parameters from a pre-defined list is received to search for a particular board in said board member store.

315. A company board data processing method as in claim 306, further comprising storing pre-defined groups of boards and/or board members comprising peer groups and parameters related to said peer groups;
wherein said user interface is generated to display a list of said pre-defined peer groups;
a user selection of one or more said pre-defined peer groups from said list is received; and
said user interface generates the user interface to display at least one of said stored pre-defined peer group related parameters for said selected pre-defined peer group.

316. A company board data processing method as in claim 315, wherein said stored pre-defined peer group related parameters relate to at least one of one or more group parameter totals, one or more group parameter averages and one or more group parameter deviations.

317. A company board data processing system comprising a program member storing processor implementable instructions; and
a processor for reading and implementing the instructions stored in the program memory;
wherein the instructions stored in the program memory comprise instructions for controlling the processor to implement the method of claim 296.

318. A carrier medium carrying computer readable instructions for controlling the computer to carry out the method of claim 296.

319. A company board data processing system comprising: a board member store storing board member related parameters for a plurality of boards; and
a user interface generator arranged to generate and display a multi axis plot of one or more of said board member related parameters for one or more boards and/or board members for comparison purposes.

320. A company board data processing system as in claim 319, further comprising a processor for determining a scale for at least one axis on said multi axis plot based on at least one of one or more totals, one or more averages and one or more deviations of a plurality of said parameters; wherein said user interface generator is adapted to display at least one axis on said multi axis plot with a scale equal to said determined scale.

321. A company board data processing system as in claim 319, wherein said board member store stores said parameters such that said board members are grouped into groups, and said user interface generator is arranged to generate a display of a multi axis plot of at least one of one or more totals, one or more averages or one or more deviations of said parameters of one or more said groups.

322. A company board data processing system as in claim 321, wherein said group comprises a board.

323. A company board data processing system as in claim 321, further comprising a parameter processor adapted to process parameters for said groups to determine at least one of one or more group parameter totals, one or more group parameter averages and one or more group parameter deviations;
wherein said user interface generator is adapted to display a plurality of said parameters and/or processed parameters on a multi axis plot, showing each axis for a different parameter type.

324. A company board data processing system as in claim 323, wherein said processor is adapted to determine a scale of at least one axis on said multi axis plot based on a predetermined level of deviation of at least one parameter already displayed on that axis from an average of a plurality of said stored and/or said processed parameters for a said group or a plurality of boards and/or board members.

325. A company board data processing system as in claim 323, wherein said parameter processor is adapted to determine the scale of at least one parameter axis by determining a minimum axis value of −n standard deviations and a maximum axis value of +m standard deviations of at least one parameter displayed on that axis from an average of a plurality of stored and/or processed parameters related to said group or a plurality of boards and/or board members, where n and m are integers.

326. A company board data processing system as in claim 325, wherein said plurality of boards and/or board members comprise all of said boards and/or board members from a specific pre-defined geographic region.

327. A company board data processing system as in claim 319 wherein said board member store stores parameters for at least some of said board members as a user selected and/or pre-defined group of board members assigned as a peer group.

328. A company board data processing system as in claim 327 further comprising:
user selector means for receiving a user selection of at least one board and/or board member for inclusion in a peer group;
a parameter processor for processing parameters for constituents of a peer group to determine at least one of one or more peer group parameter totals, one or more peer group parameter averages and one or more peer group parameter deviations; and
said user interface generator is adapted to generate the user interface to display a multi axis plot of one or more said processed parameters related to said peer group.

329. A company board data processing system as in claim 328, wherein said user selector means is arranged to receive a user selection of one or more boards for comparison with at least one of said board peer groups, and said user interface generator is adapted to generate a user interface to display a multi axis plot of one or more parameters related to members of said at least one board, to allow the or each board to be the subject of analysis.

330. A company board data processing system as in claim 328, wherein said user interface generator is adapted to generate a user interface to display a multi axis plot of the parameters related to individual members of the or each selected board.

331. A company board data processing system as in claim 328, wherein said user selector means is arranged to receive a user selection of at least one board member for comparison with said board member related peer group, and said user interface generator is adapted to generate a user interface to display a multi axis plot of the parameters related to said at least one board member, to allow the or each board member to be the subject of analysis.

332. A company board data processing system as in claim 328, wherein said user interface generator is adapted to generate a user interface to display a list of existing peer groups based on stored peer group data in said board member store; said user selector means is arranged to receive a user selection of one or more peer groups from said list; and said user interface generator is adapted to generate a user interface to display a multi axis plot of at least one of said processed parameters for at least one of said selected peer groups.

333. A company board data processing system as in claim 328, further comprising a comparison group amendment means allowing a user to amend the constituents of a peer group.

334. A company board data processing system as in claim 333, wherein said peer group amendment means is adapted to allow a user to copy one or more constituents of a peer group to another peer group.

335. A company board data processing system as in claim 328, further comprising a searching means arranged to allow a user to search for a particular board in the board member store by inputting a specific company or board member name.

336. A company board data processing system as in claim 335, wherein said searching means is adapted to allow a user to search for a particular board in said board member store by selecting one or more parameters from a pre-defined list.

337. A company board data processing system as in claim 328, wherein said user interface generator is adapted to generate a user interface to display a list of said pre-defined peer groups; said user selector means is arranged to receive a user selection of at least one said pre-defined peer groups from said list; and said user interface generator is adapted to generate a user interface to display a multi axis plot of at least one of said stored pre-defined peer group related parameters for said at least one selected pre-defined peer group.

338. A company board data processing system as in claim 337, wherein said stored pre-defined peer group related parameters relate to at least one of one or more group parameter totals, one or more group parameter averages and one or more group parameter deviations.

339. A company board data processing method comprising:
storing board member related parameters for a plurality of boards; and
generating a user interface displaying a multi axis plot of one or more of said board member related parameters for one or more boards and/or board members for comparison purposes.

340. A company board data processing method as in claim 339, further comprising determining a scale for at least one axis on said multi axis plot based on at least one of one or more totals, one or more averages and one or more deviations of a plurality of said parameters; wherein said user interface is generated to display at least one axis on said multi axis plot with a scale equal to said determined scale.

341. A company board data processing method as in claim 339, wherein said parameters are stored such that said board members are grouped into groups, and said user interface is generated to display a multi axis plot of at least one of one or more totals, one or more averages or one or more deviations of said parameters of one or more said groups.

342. A company board data processing method as in claim 341, wherein said group comprises a board.

343. A company board data processing method as in claim 341, further comprising processing parameters for said groups to determine at least one of one or more group parameter totals, one or more group parameter averages and one or more group parameter deviations; wherein said user interface is generated to display a plurality of said parameters and/or processed parameters on a multi axis plot, showing each axis for a different parameter type.

344. A company board data processing method as in claim 343, wherein a scale of at least one axis on said multi axis plot is determined based on a predetermined level of deviation of at least one parameter already displayed on that axis from an average of a plurality of said stored and/or said processed parameters for a said group or a plurality of boards and/or board members.

345. A company board data processing method as in claim 343, wherein the scale of at least one parameter axis is determined by determining a minimum axis value of −n standard deviations and a maximum axis value of +m standard deviations of at least one parameter displayed on that axis from an average of a plurality of stored and/or processed parameters related to said group or a plurality of boards and/or board members, where n and m are integers.

346. A company board data processing method as in claim 345, wherein said plurality of boards and/or board members comprise all of said boards and/or board members from a specific pre-defined geographic region.

347. A company board data processing method as in claim 339 wherein said board member store stores parameters for at least some of said board members as a user selected and/or pre-defined group of board members assigned as a peer group.

348. A company board data processing method as in claim 347 further comprising:
receiving a user selection of at least one board and/or board member for inclusion in a peer group; and
processing parameters for constituents of a peer group to determine at least one of one or more peer group parameter totals, one or more peer group parameter averages and one or more peer group parameter deviations;
wherein said user interface generates the user interface to display a multi axis plot of one or more said processed parameters related to said peer group.

349. A company board data processing method as in claim 348, wherein a user selection of one or more boards is received for comparison with at least one of said board peer groups, and said user interface is generated to display a multi axis plot of one or more parameters related to members of said at least one board, to allow the or each board to be the subject of analysis.

350. A company board data processing method as in claim 348, wherein said user interface is generated to display a multi axis plot of the parameters related to individual members of the or each selected board.

351. A company board data processing method as in claim 348, wherein a user selection of at least one board member is received for comparison with said board member related peer group, and said user interface is generated to display a multi axis plot of the parameters related to said at least one board member, to allow the or each board member to be the subject of analysis.

352. A company board data processing method as in claim 348, wherein said user interface is generated to display a list of existing peer groups based on stored peer group data in said board member store; the method including receiving a user selection of one or more peer groups from said list; wherein said user interface is generated to display a multi axis plot of at least one of said processed parameters for at least one of said selected peer groups.

353. A company board data processing method as in claim 348, further comprising receiving a user amendment of the constituents of a peer group.

354. A company board data processing method as in claim 353, wherein an instruction is received from a user to copy one or more constituents of a peer group to another peer group.

355. A company board data processing method as in claim 348, further comprising receiving a specific company or board member name from a user to search for a particular board in the board member store.

356. A company board data processing method as in claim 355, wherein one or more parameters from a pre-defined list selected by a user is received to search for a particular board in said board member store.

357. A company board data processing method as in claim 348, wherein said user interface is generated to display a list of said pre-defined peer groups; a user selection of at least one said pre-defined peer groups from said list is received; and said user interface is generated to display a multi axis plot of at least one of said stored pre-defined peer group related parameters for said at least one selected pre-defined peer group.

358. A company board data processing method as in claim 357, wherein said stored pre-defined peer group related parameters relate to at least one of one or more group parameter totals, one or more group parameter averages and one or more group parameter deviations.

359. A company board data processing system comprising a program member storing processor implementable instructions; and
a processor for reading and implementing the instructions stored in the program memory;
wherein the instructions stored in the program memory comprise instructions for controlling the processor to implement the method of claim 339.

360. A carrier medium carrying computer readable instructions for controlling the computer to carry out the method of claim 339.

361. A company board data processing system comprising:
access means for accessing a board member store storing parameters related to board members of a plurality of boards organised into boards; and
a user interface generator for generating a user interface displaying said parameters related to board members for a plurality of boards to allow comparison of boards, at board member level, and/or board members of boards.

362. A company board data processing system as in claim 361, wherein said user interface generator is adapted to generate said user interface to display at least one of one or more totals, averages and deviations of said parameters related to a group of board members or boards to allow comparison with at least one board or board member.

363. A company board data processing method comprising:
accessing a board member store storing parameters related to board members of a plurality of boards organized into boards; and
generating a user interface displaying said parameters related to board members for a plurality of boards to allow comparison of boards, at board member level, and/or board members of boards.

364. A company board data processing method as in claim 363, wherein said user interface is generated to display at least one of one or more totals, averages and deviations of said parameters related to a group of board members or boards to allow comparison with at least one board or board member.

365. A company board data processing system comprising:
a program memory storing processor implementable instructions; and
a processor for reading and implementing the instructions stored in the program memory;
wherein the instructions stored in the program memory comprise instructions for controlling the processor to implement the method of claim 363.

366. A carrier medium carrying computer readable instructions for controlling a computer to carry out the method of claim 363.

367. A company board data processing system comprising:
a store storing a number of shares owned by at least one board member in a company in which they are a board member;
means to determine current share price of the company in which said board member is a member of the board;
processor to process said number of shares and said share price to determine the value of said shares held by said board member; to determine a wealth index value for at least one said board member, comprising an increase in wealth related to said company of said board member when said share price increases by one percent; and
output means for outputting at least one of said determined wealth index values.

368. A company board data processing method comprising:
storing a number of shares owned by at least one board member in a company in which they are a board member;
determining current share price of the company in which said board member is a member of the board;
processing the number of shares and the share price to determine the value of said shares held by said board member;
determining a wealth index for at least one said board member, comprising an increase in wealth related to said company of said board member when said share price increases by 1%; and
outputting at least one of said determined wealth index values.

369. A company board data processing system, comprising:
a store storing history information for a plurality of board members, said history information including information on previous companies of which said board member has been a board member, and timing information;
a graphical display device for generating a graphical display showing performance data for companies together with the history data as a graph showing when the board member was at each company to allow a user to see how the companies have performed in relation to whether or not the board member was a member of the board for the company.

370. A system for analysing a created company board, comprising;
a store for storing parameters related to a plurality of board members;
user selection means for receiving a user selection of at least one board member for inclusion in at least one created company board;
a parameter processor to generate board parameters for constituents of said created company board; and
output means for outputting said board member parameters and/or said generated board parameters to allow the created board to be the subject of analysis.

371. A method of analyzing a created company board, comprising:
storing parameters related to a plurality of board members;
receiving a user selection of at least one board member for inclusion in at least one created company board;
generating board parameters for constituents of said created company board; and
outputting said company member parameters and/or said generated board parameters to allow the created board to be the subject of analysis.

372. A system for analyzing a created company board, comprising:
a program memory storing processor implementable instructions; and
a processor for reading and implementing the instructions stored in the program memory;
wherein the instructions stored in the program memory comprise instructions for controlling the processor to implement the method of claim 371.

373. A carrier medium carrying computer readable instructions for controlling a computer to carry out the method of claim 371.

374. A board member level recruitment and analysis tool comprising:
a store storing parameters related to a plurality of board members;
user selection means for receiving a user selection of at least one board member to be the subject of analysis, and a user selection of at least one other board member to be used as a comparison in board member analysis; and
a display generator arranged to display the parameters of said at least one user selected board member subject to analysis and said at least one user selected comparison board member to allow recruitment related comparison of the two sets of parameters.

375. A board member level recruitment and analysis tool as in claim 374, further comprising:
a processor for processing said board member parameters to determine at least one of one or more parameter totals, one or more parameter averages and one or more parameter deviations for a plurality of said user selected board members; wherein said display generator is adapted to display said processed parameters.

376. A board member level recruitment and analysis method comprising:
storing parameters related to a plurality of board members;
receiving a user selection of at least one board member to be the subject of analysis, and a user selection of at least one other board member to be used as a comparison in board member analysis; and
displaying the parameters of said at least one user selected board member subject to analysis and said at least one user selected comparison board member to allow recruitment related comparison of the two sets of parameters.

377. A board member level recruitment and analysis system, comprising:
a program memory storing processor implementable instructions; and
a processor for reading and implementing the instructions stored in the program memory;
wherein the instructions stored in the program memory comprise instructions for controlling the processor to:
store parameters related to a plurality of board members;
receive a user selection of at least one board member to be the subject of analysis, and a user selection of at least one other board member to be used as a comparison in board member analysis; and
displaying the parameters of said at least one user selected board member subject to analysis and said at least one user selected comparison board member to allow recruitment related comparison of the two sets of parameters.

378. A company board data processing system comprising:
a board member store storing board member names for a plurality of board members organized into boards;
association determining means for determining associations between said board members;
a user interface generator for generating a user interface to display at least one of said board member names and a corresponding list of said determined associations for said board member.

379. A company board data processing system as in claim 378, wherein said association determining means is adapted to determine an association to exist between two board members when said two board members both serve on the same two or more independent boards together.

380. A company board data processing system as in claim 378, wherein said association determining means is adapted to determine an association to exist between two boards when one board member serves on said two boards at the same time.

381. A company board data processing system as in claim 378, wherein said association determining means is adapted to determine indirect associations between two or more boards and/or board members via a plurality of other associations; and said user interface generator is adapted to generate a user interface to display at least one board and/or board member and a list of said network of determined associations to at least one other board and/or board member.

382. A company board data processing system as in claim 378, wherein said user interface generator is adapted to generate a user interface to display a list of board members and/or boards based on said stored board member data; further comprising a user selector means for receiving a user selection of two or more boards and/or board members from said list; wherein
said user interface generator is adapted to generate a user interface to display said names of said boards and/or board members and a list of said determined associations between said boards and/or board members.

383. A company board data processing system as in claim 381, wherein said user interface generator is adapted to generate a user interface to display a list of board members and/or boards based on said stored board member data;
further comprising a user selector means for receiving a user selection of two or more boards and/or board members from said list; wherein
said user interface generator is adapted to generate a user interface to display said names of said boards and/or board members and a list of said determined indirect associations between said boards and/or board members.

384. A company board data processing method comprising:
storing board member names for a plurality of board members organized into boards;
determining associations between said board members;
generating a user interface to display at least one of said board member names and a corresponding list of said determined associations for said board member.

385. A company board data processing method as in claim 384, wherein said determining of associations includes determining an association to exist between two board members when said two board members both serve on the same two or more independent boards together.

386. A company board data processing method as in claim 384, wherein said determining of associations includes determining an association to exist between two boards when one board member serves on said two boards at the same time.

387. A company board data processing method as in claim 384 further comprising;
determining indirect associations between two or more boards and/or board members via a plurality of other associations;
wherein said user interface displays at least one board and/or board member and a list of said network of determined associations to at least one other board and/or board member.

388. A company board data processing method as in claim 384, wherein said user interface displays a list of board members and/or boards based on said stored board member data;
further comprising receiving a user selection of two or more boards and/or board members from said list; and
in response to said user selection said user interface displays said names of said selected boards and/or board members and a list of said determined associations between said boards and/or board members.

389. A company board data processing method as in claim 387, wherein said user interface displays a list of board members and/or boards based on said stored board member data;
further comprising receiving a user selection of two or more boards and/or board members from said list; and
in response to said user selection said user interface displays said names of said selected boards and/or board members and a list of said determined indirect associations between said boards and/or board members.

390. A company board data processing system comprising a program member storing processor implementable instructions; and
a processor for reading and implementing the instructions stored in the program memory;
wherein the instructions stored in the program memory comprise instructions for controlling the processor to implement the method of claim 378.

391. A carrier medium carrying computer readable instructions for controlling the computer to carry out the method of claim 378.

392. A method of fund management using the system of claim 1.

393. A method of fund management using the system of claim 235.

394. A method of fund management using the system of claim 259.

395. A method of fund management using the system of claim 275.

396. A method of fund management using the system of claim 319.

397. A method of fund management using the system of claim 361.

398. A method of fund management using the system of claim 367.

399. A method of fund management using the system of claim 369.

400. A method of fund management using the system of claim 370.

401. A method of fund management using the system of claim 374.

402. A method of fund management using the system of claim 375.

403. A method of fund management using the system of claim 378.

404. A method of recruiting board members using the system of claim 1.

405. A method of recruiting board members using the system of claim 235.

406. A method of recruiting board members using the system of claim 259.

407. A method of recruiting board members using the system of claim 275.

408. A method of recruiting board members using the system of claim 319.

409. A method of recruiting board members using the system of claim 361.

410. A method of recruiting board members using the system of claim 367.

411. A method of recruiting board members using the system of claim 369.

412. A method of recruiting board members using the system of claim 370.

413. A method of recruiting board members using the system of claim 374.

414. A method of recruiting board members using the system of claim 375.

415. A method of recruiting board members using the system of claim 378.
